(19) United States
(12) Patent Application Publication
(10) Pub. No.: US 2024/0361149 A1
(43) Pub. Date: Oct. 31, 2024

(54) Shared Mapping Session

(71) Applicant: Google LLC, Mountain View, CA (US)

(72) Inventor: Matthew Sharifi, Kilchberg (CH)

(21) Appl. No.: 18/247,538

(22) PCT Filed: Apr. 22, 2022
(86) PCT No.: PCT/US2022/025932

§ 371 Date: Mar. 31, 2023

(51) Int. Cl. G01C 21/00; G01C 21/36

(52) U.S. Cl. CPC G01C 21/3889; G01C 21/3682

(57) ABSTRACT

A shared mapping session includes a plurality of users including a first user of a first electronic device and a second user of a second electronic device. A method for implementing the shared mapping session includes initiating the shared mapping session and receiving, from the second electronic device via the shared mapping session, second point-of-interest (POI) information associated with the second user, the second POI information including a visual element to identify a second POI as an item of interest to the second user. The method further includes displaying a user interface which displays map information indicating the visual element and a location associated with the first user, at least the visual element being simultaneously viewable in the shared mapping session to the first user via the first electronic device and the second user via the second electronic device.

### FIELD

The disclosure relates generally to shared mapping sessions for a navigation or mapping application. More particularly, the disclosure relates to methods and electronic devices for implementing a shared mapping session for a navigation or mapping application.

### BACKGROUND

Users frequently use navigation or mapping applications to look up points-of-interest such as a local business, find directions to a point-of-interest, and navigate from one place to another. In some cases, the navigation application may be used by one or more users who may be physically co-located, or may be in communication through a digital channel (e.g., over email or chat). These navigation applications only allow for a single user or single device when conducting a search for a point-of-interest. When different users wish to communicate concerning a search for a potential common meeting point, overhead and increased usage of resources is incurred when the different users need to send suggestions between each other (e.g., via a separate application such as by email, chat, or phone).

### SUMMARY

Aspects and advantages of embodiments of the disclosure will be set forth in part in the following description, or can be learned from the description, or can be learned through practice of the example embodiments.

In one or more example embodiments, a computer-implemented method for a shared mapping session is provided. The computer-implemented method may include initiating the shared mapping session which includes a plurality of electronic devices including a first electronic device having a first user and a second electronic device having a second user, receiving, from the second electronic device via the shared mapping session, second point-of-interest (POI) information associated with the second user, the second POI information including a visual element to identify a second POI as an item of interest to the second user, and displaying, on a display of the first electronic device, a user interface for the shared mapping session, the user interface displaying map information indicating the visual element and a location associated with the first user, at least the visual element being simultaneously viewable in the shared mapping session to the first user via the first electronic device and the second user via the second electronic device.

In some implementations, the method may further include transmitting a request for a real-time map view of the shared mapping session from a point of view of the second user of the second electronic device, receiving the real-time map view of the shared mapping session from the point of view of the second user of the second electronic device, and displaying in the user interface of the shared mapping session the real-time map view of the shared mapping session from the point of view of the second user of the second electronic device.

In some implementations, the method may include receiving second navigation information indicating travel information from a departure location of the second user to a location of the second POI, and based on the second navigation information, displaying in the user interface of the shared mapping session at least one of a travel time or a travel route from the departure location of the second user to the location of the second POI, simultaneously with at least one of a travel time or a travel route from a departure location of the first user to the location of the second POI.

In some implementations, the method may include transmitting, to a server, first position information associated with the first user of the first electronic device and first point-of-interest (POI) information associated with the first user, receiving, from the server, one or more recommended POIs determined by the server based at least in part on the first position information, the first POI information, second position information associated with the second user, and the second POI information, displaying in the user interface of the shared mapping session at least one of a travel time or a travel route from a departure location of the first user to the location of the one or more recommended POIs, and displaying in the user interface of the shared mapping session a location of the one or more recommended POIs that is simultaneously viewable in the shared mapping session to the second user via the second electronic device.

In some implementations, the method may further include in response to determining the first electronic device is co-located with the second electronic device, automatically transmitting invitation information to the second electronic device to join the shared mapping session, and in response to determining the first electronic device and the second electronic device are no longer co-located, automatically terminating the shared mapping session.

In some implementations, the method may further include, in response to determining the first electronic device and the second electronic device are co-located with one another and an accuracy of a location measured by the first electronic device is less than a threshold value, obtaining location information from at least one sensor of the second electronic device to improve the accuracy of the location measured by the first electronic device.

In one or more example embodiments, an electronic device (e.g., a smartphone, a table, a laptop, a personal computer, etc.) for implementing a shared mapping session is provided. The electronic device may include a display, one or more memories configured to store instructions, and one or more processors configured to execute the instructions stored in the one or more memories to: initiate a shared mapping session which includes a plurality of electronic devices including the electronic device having a first user and a second electronic device having a second user, receive, from the second electronic device via the shared mapping session, second point-of-interest (POI) information associated with the second user, the second POI information including a visual element to identify a second POI as an item of interest to the second user, and display, on the display, a user interface for the shared mapping session, the user interface displaying map information indicating a location associated with the first user, at least the visual element being simultaneously viewable in the shared mapping session to the first user via the electronic device and the second user via the second electronic device.

In some implementations, the one or more processors may be configured to transmit a request for a real-time map view of the shared mapping session from a point of view of the second user of the second electronic device, receive the real-time map view of the shared mapping session from the point of view of the second user of the second electronic device, and display in the user interface of the shared mapping session the real-time map view of the shared mapping session from the point of view of the second user of the second electronic device.

In some implementations, the one or more processors may be configured to receive second navigation information indicating travel information from a departure location of the second user to a location of the second POI, and based on the second navigation information, display in the user interface of the shared mapping session at least one of a travel time or a travel route from the departure location of the second user to the location of the second POI, simultaneously with at least one of a travel time or a travel route from a departure location of the first user to the location of the second POI.

In some implementations, the one or more processors may be configured to transmit, to a server, first position information associated with the first user of the electronic device and first point-of-interest (POI) information associated with the first user, receive, from the server, one or more recommended POIs determined by the server based at least in part on the first position information, the first POI information, second position information associated with the second user, and the second POI information, display in the user interface of the shared mapping session at least one of a travel time or a travel route from a departure location of the first user to the location of the one or more recommended POIs, and display in the user interface of the shared mapping session a location of the one or more recommended POIs that is simultaneously viewable in the shared mapping session to the second user via the second electronic device.

In some implementations, the one or more processors may be configured to, in response to a determination that the electronic device is co-located with the second electronic device, automatically transmit invitation information to the second electronic device to join the shared mapping session, and in response to a determination that the electronic device and the second electronic device are no longer co-located, automatically terminate the shared mapping session.

In some implementations, the one or more processors may be configured to, in response to a determination that the electronic device and the second electronic device are co-located with one another and an accuracy of a location measured by the electronic device is less than a threshold value, obtain location information from at least one sensor of the second electronic device to improve the accuracy of the location measured by the electronic device.

In one or more example embodiments, a computer-implemented method for a shared mapping session is provided. The computer-implemented method may include receiving a request to initiate the shared mapping session which includes a plurality of electronic devices including a first electronic device and a second electronic device, receiving, from the first electronic device via the shared mapping session, first point-of-interest (POI) information associated with a first user associated with the first electronic device, the first POI information including a visual element to identify a first POI as an item of interest to the first user, and transmitting the visual element to the second electronic device so that the visual element is simultaneously viewable in the shared mapping session to a second user via the second electronic device and the first user via the first electronic device.

In some implementations, the method may further include receiving a request from the first electronic device to provide a real-time map view of the shared mapping session from a point of view of the second user of the second electronic device, and in response to receiving the request, transmitting the real-time map view of the shared mapping session from the point of view of the second user of the second electronic device to the first electronic device.

In some implementations, the method may further include transmitting second navigation information to the first electronic device, the second navigation information indicating at least one of a travel time or a travel route from a departure location of the second user to a location of the first POI, such that at least one of a travel time or a travel route from the departure location of the second user to the location of the first POI is viewable to the first user in the shared mapping session simultaneously with at least one of a travel time or a travel route from a departure location of the first user to the location of the first POI.

In some implementations, the method may further include receiving first position information associated with the first user and second position information associated with the second user, receiving second POI information associated with the second user, determining based at least in part on the first position information, the second position information, the first POI information, and the second POI information, one or more recommended POIs, and transmitting the one or more recommended POIs to the first electronic device and the second electronic device such that the one or more recommended POIs are simultaneously viewable in the shared mapping session to the first user via the first electronic device and the second user via the second electronic device.

In some implementations, the method may further include, in response to receiving a query from the first electronic device for one or more recommended POIs, obtaining a plurality of candidate recommended POIs based on one or more search results corresponding to the query, and ranking each of the plurality of candidate recommended POIs based in part on search criteria from the query and user profile information of at least one user other than the first user among users of the plurality of electronic devices in the shared mapping session, and wherein determining the one or more recommended POIs is further based in part on the ranking of each of the plurality of candidate recommended POIs.

In some implementations, ranking each of the plurality of candidate recommended POIs may further be based in part on at least one of a travel time or a travel route from respective departure locations associated with each user of the plurality of electronic devices in the shared mapping session to respective locations of each of the plurality of candidate recommended POIs.

In some implementations, the method may further include, in response to the first electronic device being determined to be co-located with the second electronic device, automatically transmitting invitation information to the second electronic device to join the shared mapping session, and in response to determining the first electronic device and the second electronic device are no longer co-located, automatically terminating the shared mapping session.

In some implementations, the method may further include, in response to determining the first electronic device and the second electronic device are co-located with one another and receiving information indicating an accuracy of a location measured by the first electronic device is less than a threshold value, obtaining location information from at least one sensor of the second electronic device, and providing the location information obtained from the at least one sensor of the second electronic device to the first electronic device to improve the accuracy of the location measured by the first electronic device.

In one or more example embodiments, an electronic device (e.g., a server) for implementing a shared mapping session is provided. The electronic device may include one or more memories configured to store instructions, and one or more processors configured to execute the instructions stored in the one or more memories to: receive a request to initiate the shared mapping session which includes a plurality of electronic devices including a first electronic device and a second electronic device, receive, from the first electronic device via the shared mapping session, first point-of-interest (POI) information associated with a first user associated with the first electronic device, the first POI information including a visual element to identify a first POI as an item of interest to the first user, and transmit the visual element to the second electronic device so that the visual element is simultaneously viewable in the shared mapping session to a second user via the second electronic device and the first user via the first electronic device. The one or more processors of the electronic device may further be configured to carry out one or more other operations of the computer implemented method of the electronic device as described herein.

In one or more example embodiments, a computer-readable medium (e.g., a non-transitory computer-readable medium) which stores instructions that are executable by one or more processors of an electronic device and/or server is provided. In some implementations the computer-readable medium stores instructions which may include instructions to cause the one or more processors to perform one or more operations of any of the methods described herein (e.g., operations of the server and/or operations of the electronic device). The computer-readable medium may store additional instructions to execute other aspects of the server and electronic device and corresponding methods of operation, as described herein.

These and other features, aspects, and advantages of various embodiments of the disclosure will become better understood with reference to the following description, drawings, and appended claims. The accompanying drawings, which are incorporated in and constitute a part of this specification, illustrate example embodiments of the disclosure and, together with the description, serve to explain the related principles.

### BRIEF DESCRIPTION OF THE DRAWINGS

Detailed discussion of example embodiments directed to one of ordinary skill in the art is set forth in the specification, which makes reference to the appended drawings, in which:

FIG. 1 is an example system according to one or more example embodiments of the disclosure;

FIG. 2 includes example block diagrams of an electronic device and server according to one or more example embodiments of the disclosure:

FIGS. 3A-3C include example user interface screens of a user initiating a shared mapping session, according to one or more example embodiments of the disclosure:

FIGS. 4A and 4B include example user interface screens of a user annotating a point-of-interest which is viewable by another user in a shared mapping session, according to one or more example embodiments of the disclosure:

FIGS. 5A and 5B include example user interface screens of a user switching to another user's point of view in a shared mapping session, according to one or more example embodiments of the disclosure:

FIGS. 6A and 6B include example user interface screens displaying navigation information to ranked recommended points-of-interest, according to one or more example embodiments of the disclosure; and

FIGS. 7-11 include flow diagrams of example, non-limiting computer-implemented methods according to one or more example embodiments of the disclosure.

### DETAILED DESCRIPTION

Reference now will be made to embodiments of the disclosure, one or more examples of which are illustrated in the drawings, wherein like reference characters denote like elements. Each example is provided by way of explanation of the disclosure and is not intended to limit the disclosure. In fact, it will be apparent to those skilled in the art that various modifications and variations can be made to disclosure without departing from the scope or spirit of the disclosure. For instance, features illustrated or described as part of one embodiment can be used with another embodiment to yield a still further embodiment. Thus, it is intended that the disclosure covers such modifications and variations as come within the scope of the appended claims and their equivalents.

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

Examples of the disclosure are directed to a computer-implemented method by which a plurality of users (e.g., each operating respective electronic devices) are able to collaboratively share a mapping session. The shared mapping session allows for a shared browsing experience by the plurality of users (who may or may not be physically co-located). The shared mapping session allows for the plurality of users to view or share navigation routes from each respective source point to a point-of-interest that may be agreed upon through a group-based result ranking.

Users frequently use navigation or mapping applications to look up points-of-interest such as local businesses, find directions to a point-of-interest, and navigate from one place to another. In some cases the navigation application may be used by one or more users who may be physically co-located, or may be in communication through a digital channel (e.g., over email or chat). For example, two users living on different sides of a city might independently use the same navigation application to search for a restaurant to meet for dinner, sharing various suggestions over a separate chat application or by sending emails back and forth. After their dinner at the restaurant, and while physically co-present, they might independently search for a bar to have a drink on their respective electronic devices.

According to examples disclosed herein, a navigation application enables users to easily look up points-of-interest and obtain relevant directions in a collaborative shared mapping session. For example, two users living on different sides of a city might independently use the navigation application to search for a restaurant to meet for dinner, while collaboratively sharing various suggestions through a shared mapping session provided by the navigation application, thereby avoiding the need to utilize a separate application such as a chat application or email application. This saves resources on the user devices because such a separate application does not need to be invoked along with the requisite allocation of application resources on each user device. For example, a user may drop a pin on a restaurant displayed on the map which is of interest to the user, and the pin may be viewable in real-time to the other user. In addition, directions and/or a travel time to the restaurant from each of the users' respective departure locations may be displayed on the map so that each user can ascertain travel information to the restaurant, and in some cases may be able to view travel information to the restaurant for the other user. In example embodiments a server may provide recommended restaurants according to position information of each of the users and according to information provided by the users, such as preferred food types, allergies, travel limitations (e.g., a maximum distance or maximum time to travel), and the like. The recommended restaurants may be ranked by the server and provided to the users, for example in the form of a list. The server may automatically select a highest ranked restaurant and provide navigation information to each of the users in the shared mapping session, users may vote for one of the restaurants provided in the list, or a user (e.g., the initiator of the shared mapping session) may select one of the restaurants from the list. According to other examples disclosed herein, when users are physically co-located (e.g., in the restaurant together) and engaged in a shared mapping session, resources (e.g., GPS sensors) may be shared between electronic devices belonging to the users in the shared mapping session to improve a location accuracy of at least one of the electronic devices used by the users. This also allows the conserving of resources between the electronic devices of the shared mapping session.

According to an example of the disclosure, an electronic device (e.g., a server) may be configured to execute a computer-implemented method for a shared mapping session. The server may include one or more memories (e.g., a computer-readable storage medium which may be non-transitory) to store instructions and one or more processors to execute the instructions stored in the one or more memories to perform operations of the method described herein. The method may include initiating a shared mapping session which includes at least a first user and a second user among a plurality of users. For example, a user of an electronic device may execute an application installed in the electronic device (e.g., by opening one of a navigation application, a mapping application, and the like) and initiate a shared mapping session with another user. The shared mapping session may be implemented using the server which maintains each user's respective state for the shared mapping session, and provides information (e.g., updates, messages, content, notifications, data etc.) to each of the users at any time when there is an update to the shared mapping session.

The shared mapping session may be initiated (e.g., automatically initiated) by the server in response to a navigation application (mapping application) being executed by a first user (first electronic device). In some implementations, the shared mapping session may be initiated via account sharing in the application. The user may specify other users having accounts with the application service provider, and add those accounts to the shared mapping session (e.g., by specifying a user name associated with the account, an email associated with the account, and the like). As alternative or additional examples, the user may provide a QR code, a unique link, or other information to potential participant who is to be added into the shared mapping session. As further alternative or additional examples, the user may discover or receive a suggestion of a potential participant to join the shared mapping session through wireless protocols including one or more of NFC, Bluetooth, Wifi Direct, Android Nearby and the like. The user can send an invitation to the potential participant discovered via the wireless protocol requesting the potential participant to join the shared mapping session.

In some implementations, a user might create a shared mapping session across a plurality of other devices belonging to the user. In this case, the user's known devices might be populated within the mapping application such that the plurality of other devices can be added to the session.

In some implementations, to streamline the shared mapping session creation and sharing process, the mapping application may automatically provide suggestions of potential participants to add once a new session is created. For example, the mapping application may automatically provide suggestions of potential participants to add in response to discovering nearby users/devices through one or more wireless protocols described herein, or based on other contextual information (e.g., a contact of the user being co-located with the user and also having the same application active, potential participants sharing a common calendar event, etc.).

In response to receiving an invitation to join a shared mapping session, a potential participant may enter (join) the shared mapping session via various methods. For example, in some implementations, a potential participant may be required to provide additional authentication factors to confirm that they are authorized to join the shared mapping session. For example, the potential participant may be required to provide additional authentication factors when the session sharing mechanism is less secure (below a first secure sharing mechanism criteria), e.g., via a link-based session sharing mechanism. For example, in some implementations, the potential participant may not be required to provide additional authentication factors when the session sharing mechanism is more secure (above a second secure sharing mechanism criteria), e.g., via an account-based session sharing mechanism.

In some implementations, the authentication factors may be automatically generated prompts based on existing information that exists within the shared mapping session. For example, the server may transmit a query to a joining user requesting confirmation information concerning a context of the session (e.g., a location that is relevant to the shared mapping session). For example, the joining user might be asked “Which city is this session focused on?”. If the joining user correctly provides the answer (e.g., “Paris”) then the joining user will be authorized to join (e.g., by the server). If the joining user does not provide the correct answer, then the join request will be rejected (e.g., by the server), the joining user may be asked another question, or the joining user may be given another opportunity to correctly respond.

The authentication prompts may also include other confirmation information concerning a context of the session (e.g., names of other participants, such as the initiator or host of the shared mapping session). For example, the joining user might be sent or presented with a query (e.g., by the server), such as “What is the name of the owner of this session?”. If the joining user correctly provides the answer (e.g., “John”) then the joining user will be authorized to join (e.g., by the server). If the joining user does not provide the correct answer, then the join request will be rejected (e.g., by the server), the joining user may be asked another question, or the joining user may be given another opportunity to correctly respond.

In the above examples, the joining user's input may be fuzzily matched (e.g., by the server) against the expected text, for example to allow for variations in spelling or shortened versions. For example, one or more processors of the server may perform fuzzy matching based on text normalization techniques, or via an ML-based model which embeds both the input and the expected value into a common feature space.

In some implementations, as new users are added to the shared mapping session (e.g., by the server), one or more of the existing users in the shared mapping session will be notified of the joining event so they are aware of others who join the shared mapping session. For example, the shared mapping session may provide a message to each existing user in the shared mapping session indicating another user has joined.

According to an example of the disclosure, the server may receive first position information associated with a first user in the shared mapping session and position information associated with other users who have joined the shared mapping session (e.g., second position information associated with a second user who has joined the shared mapping session). The position information of each of the users may be used (e.g., by the server) to determine a common meeting point (i.e., a point-of-interest) for the users. For example, the position information may indicate a geographic location of the electronic device of a user which executes the navigation application with the shared mapping session (e.g., based on a GPS signal, or a location determined based on a wireless network). For example, the position information may indicate a geographic location of a planned departure location of the user (e.g., a geographic location of a user's home, workplace, or other location), which may be based on an address, world coordinate system, or other location information that may be publicly available. Each of the users may be traveling from a different source location (e.g., their respective home or work locations). To find a suitable common meeting point, each user in the shared mapping session can provide their own origin (departure) point. For example, each time a user joins the shared mapping session, the server may receive a location (origin or planned departure point) of the user (e.g., a current location of the electronic device being used by the user, or of a planned departure location of the user such as the user's home, place of employment, or other location). The location of the user may be provided automatically to the server upon joining the shared mapping session, or the user may be prompted when joining the shared mapping session to provide the origin point or departure location. Other information, such as a preferred mode of transit of the user (e.g., car, bus, train, etc.) may also be provided by the user (e.g., to the server). In some implementations the departure location of a user may be automatically shared with other users via the shared mapping session, while in other implementations the departure location of a user may be shared with only authorized users via the shared mapping session, or the departure location of the user may not be shared with other users at all.

The server may use the departure location information of each of the users to determine possible meeting points (points-of-interest). For example, the server may use the departure location information of each of the users to determine locations of points-of-interest which are equidistant for all the users in the shared mapping session, or to determine locations of points-of-interest which are easily accessible for all the users in the shared mapping session. The term “easily accessible” may refer to points-of-interest which are located within a preset distance of each of the users in the shared mapping session. For example, if each of three users specify a maximum distance they are willing to travel is 4 miles, 5 miles, and 3 miles, respectively, the server may set the preset distance to the minimum distance of 3 miles, or to an average of the specified distances (4 miles). As another example, the term “easily accessible” may refer to points-of-interest which are located within a preset time of each of the users in the shared mapping session given a specified mode of travel for each of the users. For example, if each of three users specify a maximum time they are willing to travel is 30 minutes, 10 minutes, and 20 minutes, respectively, the server may set the preset time to the minimum time of 10 minutes, or to an average of the specified times (20 minutes). As another example, the term “easily accessible” may refer to points-of-interest which satisfy other criteria such that the point-of-interest can be reached in a convenient manner and/or is also capable of being reached by each of the users in the shared mapping session (e.g., destinations which can be reached by or can accommodate users with disabilities).

According to an example of the disclosure, the server may be configured to execute the computer-implemented method for the shared mapping session which includes the operation of receiving, by the server, first point-of-interest (POI) information associated with the first user and POI information associated with other users in the shared mapping session (e.g., second POI information associated with a second user). A point-of-interest may include any feature, place, or destination which is of interest to a user or the plurality of users in the shared mapping session. For example, one or more of the users may wish to travel to or visit to meet with at least one other user in the shared mapping session. For example, a point-of-interest may include a restaurant, museum, sporting venue, concert hall, amusement park, school, place of business, grocery store, gas station, theater, shopping mall, lodging, and the like. Point-of-interest information may include any information which may be useful in identifying a point-of-interest. For example, the point-of-interest information may include any information which may be included in a search query by a user for a point-of-interest. For example, the point-of-interest information may include category information (e.g., lodging, restaurant, etc.), a name of the point-of-interest (e.g., a name of a stadium, a restaurant, etc.), preferences concerning the point-of-interest (e.g., a preference for a particular environment such as a quiet atmosphere, a preference for a particular type of food such as vegetarian food, a preference for a minimum review rating by other users and/or critics such as three stars or at least a 4.0 rating out of 5.0, a preference for a particular travel time and/or travel distance such as less than ten minutes away from the user, a preference for a particular budget level such as a $$ or $$$ rating, and the like). For example, the point-of-interest information may include user profile information of a user which may be used to identify a point-of-interest. The user profile information may include information about the user such as demographic information (e.g., age, gender, etc.), address information, preferences such as food preferences, hotel preferences, movie preferences, etc. The user profile information may also include user history information such as past reviews of points-of-interest by the user, previous visits to points-of-interest, spending habits of the user, and the like. In some implementations the point-of-interest information received by the server may automatically include the user profile information of a user if that user has authorized or allowed their user profile information to be shared with the server.

The shared mapping session allows a plurality of users to join into a shared mapping session in the application (e.g., a map application, a navigation application, and the like), where each user can indicate a preference for a point-of-interest in the shared mapping session which is immediately visible to other users in the shared mapping session (e.g., in real-time). For example, a user may indicate a preference for a point-of-interest by placing a visual element or icon next to a location of the point-of-interest in the map. For example, the user may place a star on or next to a location of the point-of-interest in the map, or drop a pin on or next to a location of the point-of-interest in the map. The visual element or icon may be immediately visible to other users in the shared mapping session. For example, the visual element or icon may be color coded or have some other unique identifier which represents the user, so that other users in the shared mapping session are able to recognize which user has indicated a preference for the point-of-interest.

In an example embodiment, a first user may indicate a preference for a first POI by placing a visual element such as a pin next to the first POI in the map. The first POI information which is received by the server may include the visual element representing the preference of the first user for the first POI, and the server may transmit, in response to the first user indicating the preference for the first POI, the visual element to other users in the shared mapping session (e.g., the second user) such that the visual element is viewable by the other users (e.g., the second user) in the shared mapping session in real-time. For example, a user may highlight or mark specific places and/or routes, and may add notes associated with them. This information may be included as part of the POI information transmitted to the server from a user and shared with other users in the shared mapping session.

As mentioned above, the server may obtain position information of users in the shared mapping session as well as point-of-interest information from one or more of the users in the shared mapping session. The server may use the position information of the users and the point-of-interest information to determine one or more recommended POIs to be offered to the users in the shared mapping session. According to an example of the disclosure, the server may be configured to execute the computer-implemented method for the shared mapping session which includes the operation of determining, based at least in part on first position information of a first user, second position information of a second user, first POI information provided to the server by the first user, and second POI information provided to the server by the second user, one or more recommended POIs. Thus, users in the shared mapping session may obtain recommendations from the server for one or more points-of-interest based on one or more queries sent to the server from one or more users in the shared mapping session. The server may determine the one or more recommended POIs by taking into account the search criteria provided by the one or more users (e.g. POI information such as the search term “restaurant”) and the server may use user profile information (if shared) of one or more of the users in the shared mapping session to suggest one or more recommended POIs which all users would like, and also which would be convenient for each user to travel to. According to an example of the disclosure, the server may be configured to execute the computer-implemented method for the shared mapping session which includes the operation of transmitting the one or more recommended POIs to the first user and to other users in the shared mapping session (e.g., a second user) such that the one or more recommended POIs are viewable (e.g., simultaneously viewable) to the first user and the other users (e.g., the second user) in the shared mapping session.

In conjunction with determining one or more recommended POIs, the server may also determine navigation information (e.g., directions, travel time, alternate routes, etc.) to the one or more recommended POIs from each of the origin or departure locations of each of the users in the shared mapping session. The server may also transmit navigation information to respective users so that each user can view the navigation information from their respective origin point or departure location to the one or more recommended POIs. Navigation information to a recommended POI may be distinguished from navigation information to other recommended POIs by the use of color, by using different markings for the travel route and/or travel time, or combinations thereof. According to an example of the disclosure, the server may be configured to execute the computer-implemented method for the shared mapping session which includes the operation of transmitting first navigation information to the first user, the first navigation information indicating travel information from a location associated with the first user to a location of the one or more recommended POIs such that at least one of a travel time or a travel route from the location associated with the first user to the location of the one or more recommended POIs is viewable to the first user in the shared mapping session. According to an example of the disclosure, the server may be configured to execute the computer-implemented method for the shared mapping session which includes the operation of transmitting navigation information to other users, such as second navigation information to a second user. The second navigation information may indicate travel information from a location associated with the second user to a location of the one or more recommended POIs such that at least one of a travel time or a travel route from the location associated with the second user to the location of the one or more recommended POIs is viewable to the second user in the shared mapping session.

In one or more example embodiments, a computer-implemented method for a shared mapping session is provided. The computer-implemented method may include initiating the shared mapping session which includes a plurality of electronic devices including a first electronic device and a second electronic device, receiving, from the second electronic device via the shared mapping session, receiving second navigation information associated with a second user of the second device, the second navigation information indicating travel information from a location associated with the second user (e.g., an origin point of the second user) to a location of a point-of-interest (POI), and displaying, on a display of the first electronic device, a user interface for the shared mapping session, the user interface displaying map information indicating first navigation information indicating travel information from a location associated with the first user (e.g., an origin point of the first user) to the location of the POI, wherein the first navigation information includes at least one of a travel time or a travel route from the location associated with the first user to the location of the POI and the second navigation information includes at least one of a travel time or a travel route from the location associated with the second user to the location of the POI.

In some implementations, the server may transmit navigation information to a user in response to a request from the user for navigation information to a point-of-interest. For example, first navigation information may be transmitted to a first user in response to the server receiving a request from the first user and/or the second user for directions to one or more recommended POIs or to a POI that is selected by the first user and/or the second user. For example, the server may determine and transmit directions to a POI given a plurality of origin points corresponding to a plurality of users in the shared mapping session. In response to a request from a user in the shared mapping session for directions to a selected location or point-of-interest, the server may determine and transmit, to each user in the shared mapping session, directions from a respective origin point or departure location to the selected point-of-interest. Thus, each user can quickly ascertain travel information to the selected point-of-interest from their respective origin point or departure location, and determine whether the selected point-of-interest is acceptable in terms of travel. This allows each of the users to easily find a point-of-interest which can be reached by all of the users in a single step. For example, in the shared mapping session each user can indicate whether the POI is at an acceptable location (e.g., by a voting mechanism within the shared mapping session, by providing a “thumbs-up” indication within the shared mapping session, or by providing some other indication or visual element within the shared mapping session (e.g., a heart, happy face, etc.).

In some implementations, in response to a request from a user in the shared mapping session for directions to a selected location or point-of-interest, the server may determine and transmit, to each user in the shared mapping session, directions from one or more origin points or departure locations of one or more users in the shared mapping session to the selected point-of-interest. According to an example of the disclosure, the server may be configured to execute the computer-implemented method for the shared mapping session which includes the operation of transmitting navigation information of other users (e.g. a second user) to the first user, such that at least one of a travel time or a travel route from the location associated with the other users (e.g., the second user) to the location of one or more recommended POIs is viewable to the first user in the shared mapping session. The navigation information of the other users may be viewable simultaneously with at least one of a travel time or a travel route from the location associated with the first user to the location of the one or more recommended POIs. That is, in some implementations a user may be able to view travel routes and/or travel times from origin points or departure locations of other users to a selected or recommended point-of-interest. Thus, a user can quickly ascertain travel information (e.g., directions and/or travel times) to the selected or recommended point-of-interest from origin points or departure locations of other users to the selected or recommended point-of-interest (as well as travel information from their own origin point or departure location to the selected or recommended point-of-interest). Accordingly, users in the shared mapping session can gain a better understanding of the travel information of the other users in determining whether the selected or recommended point-of-interest is acceptable in terms of travel convenience. For example, users in the shared mapping session may obtain recommendations of points-of-interest to travel to which would be easily accessible by all of the users in the shared mapping session. For example, travel information to different recommendations of points-of-interest can be represented by color-coding on the map. For example, recommendations of points-of-interest which are most accessible can be represented by the color green, points-of-interest which are least accessible can be represented by the color red, and points-of-interest which are of moderate accessibility can be represented by the color yellow.

According to one or more examples of the disclosure, it is possible for a user to switch or snap to another user's viewpoint to enable a shared viewing experience. For example, if a first user is browsing a particular area in London, then a second user can select an option within the shared mapping session to immediately hop to the first user's location on the map. According to an example of the disclosure, the server may be configured to execute the computer-implemented method for the shared mapping session which includes the operation of receiving a request from a first user to provide a real-time map view of the shared mapping session from a point of view of a second user. In response to receiving the request the server may transmit the real-time map view of the shared mapping session from the point of view of the second user to the first user.

According to examples of the disclosure, the server may use the position information of the users and the point-of-interest information to determine one or more recommended POIs to be offered to the users in the shared mapping session. If a group of users is collaborating in a shared mapping session, it will often be useful to find points-of-interest which are relevant to all of the users. For example, the one or more recommended POIs may be determined by the server according to a ranking mechanism. Any one of the users may perform a query or request for suggestions or recommendations via the shared mapping session. In the context of a shared mapping session, these results can be ranked based on the POI information received by the server from users in the shared mapping session. The POI information may include user profile information of one or more users in the shared mapping session. Ranking of the POIs can help ensure that a recommended POI is relevant to most if not all of the users in the shared mapping session (e.g., to ensure that the type of restaurant would be of interest to all participants), and also to ensure that a recommended POI can be easily accessed from the origin point or departure location of the users in the shared mapping session.

As mentioned above, for any action that requires ranking of places or routes, this will be done collectively for all users in the shared mapping session. For example, if a user searches for “restaurant”, the recommended restaurants returned will be ranked such that they would be of mutual interest to all users in the shared mapping session (and not only the query initiator). For example, ranking of the POI may be performed (e.g., by the server) by extending current ranking mechanisms to jointly score a candidate POI with respect to each user and come up with an average (or other aggregate) score. The results may be sorted by the server based on the aggregate scores before displaying the top results to the users in the shared mapping session. As an additional input for ranking a candidate POI, respective travel times for each of the users in the shared mapping session may be considered. Candidate POIs which exceed a specified travel time for any one of the users may be excluded as possible recommended POIs and incorporate this into the ranking signal. Candidate POIs with a shorter average travel time for all of the users in the shared mapping session (e.g., less than a first threshold value) may be given greater weight than candidate POIs with a longer travel time (e.g., greater than the first threshold value, or greater than a second threshold value). Accordingly, the one or more recommended POIs suggested by the server may have an expected travel time that is not too high for any one user.

In one or more example embodiments, a computer-implemented method for a shared mapping session is provided. The computer-implemented method may include receiving, by the server, first position information associated with a first user of a first electronic device among a plurality of electronic devices in the shared mapping session and second position information associated with a second user of a second electronic device among the plurality of electronic devices in the shared mapping session, receiving, by the server, first point-of-interest (POI) information associated with the first user and second POI information associated with the second user, determining, by the server and based at least in part on the first position information, the second position information, the first POI information, and the second POI information, one or more recommended POIs, and transmitting, by the server, the one or more recommended POIs to the first electronic device and the second electronic device such that the one or more recommended POIs are simultaneously viewable to the first user and the second user in the shared mapping session.

According to an example of the disclosure, the server may be configured to execute the computer-implemented method for the shared mapping session which includes the operation of, in response to receiving a query from a first user for one or more recommended POIs, obtaining a plurality of candidate recommended POIs based on one or more search results corresponding to the query. The method may further include ranking each of the plurality of candidate recommended POIs based in part on search criteria from the query and user profile information of at least one other user among the plurality of users in the shared mapping session (e.g., every user in the shared mapping session which shares their user profile information). The method may further include ranking each of the plurality of candidate recommended POIs based in part on at least one of a travel time or a travel route from respective locations associated with every user among the plurality of users in the shared mapping session to respective locations of each of the plurality of candidate recommended POIs. The method may further include determining the one or more recommended POIs based in part on the ranking of each of the plurality of candidate recommended POIs. The method may further include excluding candidate recommended POIs which have a travel time for any user among the plurality of users in the shared mapping session greater than a threshold value as one of the one or more recommended POIs

According to an example of the disclosure, an electronic device (e.g., a smartphone, laptop, tablet, etc.) may be configured to execute a computer-implemented method for a shared mapping session. The electronic device may include one or more memories (e.g., a computer-readable storage medium which may be non-transitory) to store instructions and one or more processors to execute the instructions stored in the one or more memories to perform operations of the method described herein. The method may include executing, by the electronic device (e.g., a first electronic device), a navigation application (mapping application) and initiating the shared mapping session via the navigation application. The method may further include transmitting invitation information to one or more other electronic devices (e.g., a second electronic device) for the one or more other electronic devices to join the shared mapping session which includes a plurality of electronic devices.

As explained previously, in some implementations, the shared mapping session may be initiated via account sharing in the application, by the electronic device providing a QR code, a unique link, or other information to a potential participant who is to be added into the shared mapping session. As further alternative or additional examples, the electronic device may discover or receive a suggestion of a potential participant to join the shared mapping session through wireless protocols including one or more of NFC, Bluetooth, Wifi Direct, Android Nearby and the like. The electronic device can send an invitation to the potential participant discovered via the wireless protocol requesting the potential participant to join the shared mapping session.

In some implementations, a user of the electronic device might create a shared mapping session across a plurality of other electronic devices belonging to the user. In this case, the user's known electronic devices might be populated within the mapping application such that the plurality of other devices can be added to the session.

According to an example of the disclosure, the electronic device may be configured to execute the computer-implemented method for the shared mapping session which includes the operation of transmitting, to the server, position information (e.g., first position information) associated with the electronic device (e.g., first electronic device) and point-of-interest (POI) information (e.g., first POI information) associated with a user (e.g., first user) associated with the electronic device (e.g., first electronic device). The method may further include the operation of receiving, from the server, one or more recommended POIs determined by the server based at least in part on the first position information, the first POI information, position information associated with other electronic devices (e.g., second position information associated with the second electronic device), and POI information associated with other users in the shared mapping session (e.g., second POI information associated with a second user of the second electronic device). The method may further include receiving, from the server, first navigation information indicating travel information from a location associated with the electronic device (e.g., the first electronic device) to a location of the one or more recommended POIs. The method may further include displaying, on a display of the electronic device (e.g., the first electronic device), a user interface of the shared mapping session, the user interface displaying map information indicating a location of the electronic device (e.g., the first electronic device), a location of the one or more recommended POIs, and at least one of a travel time or a travel route from the location of the electronic device (e.g., the first electronic device) to the location of the one or more recommended POIs.

As explained previously, a user in the shared mapping session may wish to indicate a preference for a POI or simply notify other users of a possible POI which may be of interest to the other users. For example, a user of the electronic device may indicate a preference for a point-of-interest by placing a visual element or icon next to a location of the point-of-interest in the map which is displayed in the user interface of the navigation application. For example, the user may place a star on or next to a location of the point-of-interest in the map, or drop a pin on or next to a location of the point-of-interest in the map which is displayed in the user interface of the navigation application. According to an example of the disclosure, the first POI information may include a visual element representing a preference of the first user for a first POI, and the visual element may be viewable to other users (e.g., the second user) in the shared mapping session such that the visual element is viewable by users of the plurality of devices in the shared mapping session in real-time. According to an example of the disclosure, the method may include the electronic device receiving, from the server, the second POI information, the second POI information including a visual element representing a preference of the second user for a second POI, and displaying in the user interface of the shared mapping session, in real-time, a location of the second POI and the visual element.

As explained previously, navigation information to a recommended POI for a user may be shared with other users, so that the other users can ascertain travel information for the user to the recommended POI. According to an example of the disclosure, the method may include the electronic device receiving, from the server, second navigation information indicating travel information from a location of the second electronic device to a location of the one or more recommended POIs, and displaying in the user interface of the shared mapping session at least one of a travel time or a travel route from the location of the second electronic device to the location of the one or more recommended POIs, simultaneously with at least one of the travel time or the travel route from the location of the first electronic device to the location of the one or more recommended POIs.

As explained previously, a user of an electronic device may also view another user's viewpoint to have a shared viewing experience. According to an example of the disclosure, the method may include the electronic device transmitting a request for a real-time map view of the shared mapping session from a point of view of the second user of the second electronic device, receiving the real-time map view of the shared mapping session from the point of view of the second user of the second electronic device, and displaying in the user interface of the shared mapping session the real-time map view of the shared mapping session from the point of view of the second user of the second electronic device.

According to an example of the disclosure, a shared mapping session may be created based on whether users of the shared mapping session are co-located with one another. In some instances, a shared mapping session may be carried out when two or more users of respective electronic devices are physically co-present. For example, after two users meet up in a city, they might each start searching for a point-of-interest using a navigation or mapping application. The shared mapping session as described herein provides a mechanism to easily create such a shared mapping session, and may also automatically terminate and/or delete the shared mapping session once one or more of the electronic devices in the shared mapping session determines that the users are no longer co-located. For example, according to the method disclosed herein, the electronic device and/or server may automatically transmit invitation information to one or more other electronic devices (e.g., the second electronic device) in response to the electronic device being determined to be co-located with the one or more other electronic devices (e.g., the second electronic device) and each of the first electronic device and the second electronic having a navigation or mapping application active. For example, in this way a shared mapping session may automatically be initiated. In some implementations, the shared mapping session may automatically be initiated but still require further authentication measures to ensure the users intend to have a shared mapping session. For example, according to the method disclosed herein, the electronic device may, in response to determining the first electronic device and the second electronic are no longer co-located, automatically terminate or delete the shared mapping session. For example, the shared mapping session may be ended and/or a history of the shared mapping session may be deleted.

In one or more example embodiments, an electronic device (e.g., a smartphone, a table, a laptop, a personal computer, etc.) for implementing a shared mapping session is provided. The electronic device may include a display, one or more memories configured to store instructions, and one or more processors configured to execute the instructions stored in the one or more memories to: execute a navigation application, and initiate (e.g., automatically) a shared mapping session with a second electronic device based on information indicating the second electronic device is co-located with the electronic device. The information indicating the second electronic device is co-located with the electronic device may be obtained by the electronic device itself, or may be obtained from a server which has determined the electronic device and second electronic device are co-located.

According to an example of the disclosure, a shared mapping session between users of the shared mapping session who are co-located with one another may additionally allow for the sharing of sensors from their respective electronic devices. That is, when a plurality of users in the shared mapping session are detected to be in close physical proximity to one another, the shared mapping session can create a joint location stack to provide more efficient and more accurate location detection, e.g., to show a more accurate location of the electronic device (e.g., via a blue dot on the map), or to allow for an improved navigation mode. In an example, the server may detect that the plurality of users in the shared mapping session are in close physical proximity to one another based on position information of the plurality of users being provided to the server. Additionally, or alternatively, one of the electronic devices of a user may detect at least one other electronic device (e.g., belonging to another user) which is in close physical proximity. In response to the server detecting that the plurality of users in the shared mapping session are in close physical proximity to one another, and in response to detecting that at least one electronic device (e.g., the first electronic device) has a location accuracy and/or power level below a threshold, the server may request at least one other electronic device associated with the users in the shared mapping session to provide location information to the first electronic device to form a joint location stack. Additionally, or alternatively, in response to a first electronic device detecting that the plurality of users in the shared mapping session are in close physical proximity to one another, and in response to detecting that the first electronic device has a location accuracy and/or power level below a threshold, the first electronic device may request at least one other electronic device associated with the users in the shared mapping session to provide location information to the first electronic device to form a joint location stack. For example, according to the method disclosed herein, the first electronic device may, in response to determining the first electronic device and a second electronic are co-located with one another and an accuracy of a location measured by the first electronic device is less than a threshold value, obtain location information from at least one sensor of the second electronic device to create a joint location stack to improve the accuracy of the location measured by the first electronic device.

For example, one user's electronic device might provide GPS capabilities for others, e.g., if it has more power or a more accurate sensor reading, or if another user's electronic device has low power or a low accurate sensor reading. More generally, various sensors from different devices (e.g., a GPS disposed in a first electronic device, a WiFi/cell disposed in a second electronic device, a camera disposed in a third electronic device) may be combined to produce a single, more accurate location measurement (e.g., a joint location stack). In another example, a joint location stack may be constructed from two or more electronic devices that are all owned by the same user. For example, a user might pair their watch and phone together to collaboratively provide a higher accuracy location signal whenever the two devices are in close proximity.

Forming a joint location stack (between electronic devices belonging to different users or to a same user), may be performed by fusing the available sensors from the different electronic devices. For example, one electronic device might have a compass and cell access whereas another electronic device may have only WiFi. A joint location stack may also be implemented when an electronic device is a wearable (e.g., smart eyewear) and can provide a visual positioning signal that can be combined with position information obtained by another electronic device (e.g., via GPS). As an additional example, a joint location stack may be implemented when an electronic device is low on power and unable to run a GPS at a high frequency. In order to fuse sensors from different electronic devices together, a machine learned model may be implemented. For example, the machine learned model may be configured to accept sensor outputs from different electronic devices and combine them into a single prediction. Each sensor may be weighted by its respective confidence or measurement accuracy. Some sensors may be excluded entirely from inference (e.g., to save power). For example, decisions to include or exclude sensors from the joint location stack may be made based on a heuristic.

In one or more example embodiments, an electronic device (e.g., a smartphone, a table, a laptop, a personal computer, etc.) for implementing a shared mapping session is provided. The electronic device may include a display, one or more memories configured to store instructions, and one or more processors configured to execute the instructions stored in the one or more memories to: initiate a shared mapping session which includes a plurality of electronic devices including the electronic device and a second electronic device, receive information indicating the second electronic device is co-located with the electronic device, and in response to the electronic device and the second electronic device being co-located with one another and an accuracy of a location measured by the electronic device is less than a threshold value, obtain location information from at least one sensor of the second electronic device to improve the accuracy of the location measured by the electronic device. The information indicating the second electronic device is co-located with the electronic device may be obtained by the electronic device itself, or may be obtained from a server which has determined the electronic device and second electronic device are co-located. In one or more example embodiments, a server for implementing a shared mapping session is provided. The server may include one or more memories configured to store instructions, and one or more processors configured to execute the instructions stored in the one or more memories to: initiate a shared mapping session which includes a plurality of electronic devices including a first electronic device and a second electronic device, receive information indicating the second electronic device is co-located with the first electronic device, and in response to the first electronic device and the second electronic device being co-located with one another and an accuracy of a location measured by the first electronic device is less than a threshold value, obtain location information from at least one sensor of the second electronic device and provide (transmit) the location information obtained from the at least one sensor of the second electronic device to the first electronic device to improve the accuracy of the location measured by the first electronic device.

In some examples, although a navigation or mapping application may be closed by a user, the shared mapping session may remain active. For example, if a user reopens the navigation application, the user may be able to view a list of active shared mapping sessions. The user may select one of the shared mapping sessions from the list to switch into that shared mapping session again. The list of shared mapping sessions may be ranked based on various factors, such as based on recency, the user's current location, if other users from the shared mapping session are co-located, etc. In some implementations, a shared mapping session may be sticky, i.e., the user may automatically join the shared mapping session upon reopening the navigation or mapping application. A sticky shared mapping session may be useful in instances where the shared mapping session exists for a plurality of electronic devices belonging to the same user. That is, the user may switch back into a shared mapping session even when using a different electronic device.

Shared mapping sessions may remain active indefinitely, or may automatically terminate (e.g., after inactivity lasting longer than a predetermined duration of time such as a few minutes, a few hours, a few days, etc.). If the shared mapping session was initiated by two or more users who were co-located, then the shared mapping session may be terminated when the users are no longer co-located. Additionally or alternatively, a user may explicitly terminate or delete a shared mapping session after it is no longer required.

According to examples described herein, collaborative shared mapping sessions allow for shared browsing and easy identification of places or areas which are convenient to reach given each user's starting location. In addition, such shared mapping sessions may enable the shared use of resources (e.g., GPS sensors) when the respective electronic devices of the users are co-located. Previous navigation applications only allowed for a single user or single device when conducting a search for a point-of-interest. When different users wish to communicate concerning a search for a potential common meeting point, overhead and increased usage of resources is incurred when the different users need to send suggestions between each other (e.g., via a separate application such as by email, chat, or phone).

One or more benefits of the disclosure include allowing users to easily plan and share geo-related information amongst one another. As mentioned above, previously this would be done by sharing links to places or routes between users, which requires activating other software applications on the user's device (e.g. email, chat) in addition to a mapping application and sending the link to a point-of-interest across a channel using the other software application. According to one or more examples of the disclosure, sharing recommendations and links to points-of-interest can be accomplished directly through the mapping application, saving both time and device resources. That is, all of the activity may occur in a single application (e.g., the mapping application). In one or more other examples of the disclosure, in response to a shared mapping session being initiated for two or more users who are co-located (or two or more devices belonging to a same user), one or more sensors (e.g., a GPS, camera, WiFi) from one user's device may be combined with one or more sensors of another user's device (or another device of the same user), so as to produce a single, more accurate location measurement. Thus, technical benefits such as resource savings and location accuracy improvements may also be achieved.

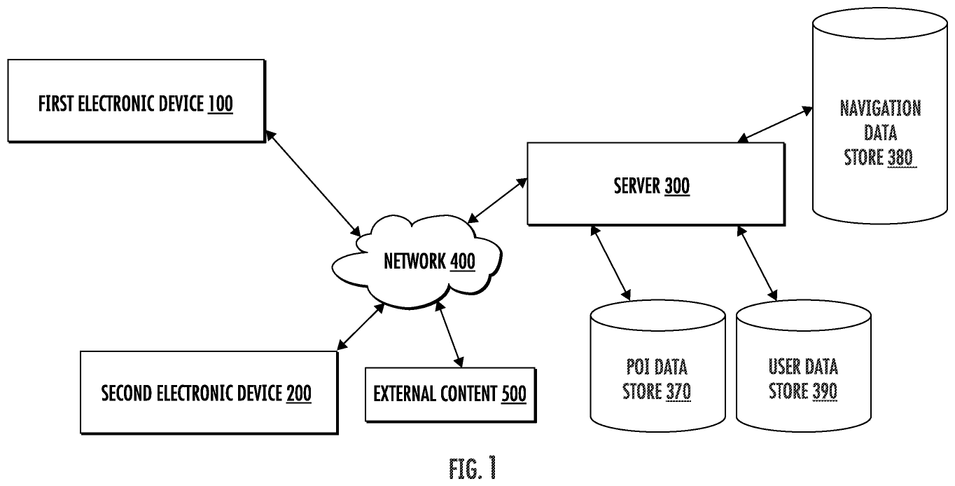

Referring now to the drawings, FIG. 1 is an example system according to one or more example embodiments of the disclosure. FIG. 1 illustrates an example of a system which includes a first electronic device 100, a second electronic device 200, a server 300, and external content 500, which may be in communication with one another over a network 400. For example, the first electronic device 100 and the second electronic device 200 can include any of a personal computer, a smartphone, a tablet computer, a global positioning service device, a smartwatch, and the like. The network may include any type of communications network such as a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like.

As will be explained in more detail below, in some implementations the first electronic device 100 and second electronic device 200 may participate in a shared mapping session via server 300 over network 400. The shared mapping session may include a plurality of electronic devices, including electronic devices other than the first electronic device 100 and second electronic device 200.

In some example embodiments, the server 300 may obtain data from one or more of a POI data store 370, a navigation data store 380, and a user data store 390, to implement various operations and aspects of the shared mapping session as disclosed herein. The POI data store 370, navigation data store 380, and user data store 390 may be integrally provided with the server 300 (e.g., as part of the memory 320 of the server 300) or may be separately (e.g., remotely) provided. Further, POI data store 370, a navigation data store 380, and a user data store 390 can be combined as a single data store (database), or may be a plurality of respective data stores. Data stored in one data store (e.g., the POI data store 370) may overlap with some data stored in another data store (e.g., the navigation data store 380). In some implementations, one data store (e.g., the POI data store 370) may reference data that is stored in another data store (e.g., the navigation data store 380).

POI data store 370 can store information about points-of-interest, for example, for points-of-interest in an area or region associated with one or more geographic areas. A point-of-interest may include any destination or place. For example, a point-of-interest may include a restaurant, museum, sporting venue, concert hall, amusement park, school, place of business, grocery store, gas station, theater, shopping mall, lodging, and the like. Point-of-interest data which is stored in the POI data store 370 may include any information which is associated with the POI. For example, the POI data store 370 may include location information for the POI, hours of operation for the POI, a phone number for the POI, reviews concerning the POI, financial information associated with the POI (e.g., the average cost for a service provided and/or goods sold at the POI such as a meal, a ticket, a room, etc.), environmental information concerning the POI (e.g., a noise level, an ambiance description, a traffic level, etc., which may be in real-time), a description of the types of services provided and/or goods sold, languages spoken at the POI, a URL for the POI, image content associated with the POI, etc.

Navigation data store 380 may store or provide map data/geospatial data to be used by server 300. Example geospatial data includes geographic imagery (e.g., digital maps, satellite images, aerial photographs, street-level photographs, synthetic models, etc.), tables, vector data (e.g. vector representations of roads, parcels, buildings, etc.), point of interest data, or other suitable geospatial data associated with one or more geographic areas. In some examples, the map data can include a series of sub-maps, each sub-map including data for a geographic area including objects (e.g., buildings or other static features), paths of travel (e.g., roads, highways, public transportation lines, walking paths, and so on), and other features of interest. Navigation data store 380 can be used by server 300 to provide navigational directions, perform point of interest searches, provide point of interest location or categorization data, determine distances, routes, or travel times between locations, or any other suitable use or task required or beneficial for performing operations of the example embodiments as disclosed herein.

In some example embodiments, the user data store 390 can represent a single database. In some embodiments, the user data store 390 represents a plurality of different databases accessible to the server 300. In some examples, the user data store 390 can include a current user position and heading data. In some examples, the user data store 390 can include information regarding one or more user profiles, including a variety of user data such as user preference data, user demographic data, user calendar data, user social network data, user historical travel data, and the like. For example, the user data store 390 can include, but is not limited to, email data including textual content, images, email-associated calendar information, or contact information: social media data including comments, reviews, check-ins, likes, invitations, contacts, or reservations: calendar application data including dates, times, events, description, or other content: virtual wallet data including purchases, electronic tickets, coupons, or deals: scheduling data: location data: SMS data: or other suitable data associated with a user account. According to one or more examples of the disclosure, such data can be analyzed to determine preferences of the user with respect to a POI, to determine preferences of the user with respect to traveling (e.g., a mode of transportation, an allowable time for traveling, etc.), to determine possible recommendations for POIs for the user, to determine possible travel routes and modes of transportation for the user to a POI, and the like.

The user data store 390 is provided to illustrate potential data that could be analyzed, in some embodiments, by the server 300 to identify user preferences, to recommend POIs, to determine possible travel routes to a POI, to determine modes of transportation to be used to travel to a POI, etc. However, such user data may not be collected, used, or analyzed unless the user has consented after being informed of what data is collected and how such data is used. Further, in some embodiments, the user can be provided with a tool (e.g., in the navigation application or via a user account) to revoke or modify the scope of permissions. In addition, certain information or data can be treated in one or more ways before it is stored or used, so that personally identifiable information is removed or stored in an encrypted fashion. Thus, particular user information stored in the user data store 390 may or may not be accessible to the server 300 based on permissions given by the user, or such data may not be stored in the user data store 390 at all.

External content 500 can be any form of external content including news articles, webpages, video files, audio files, written descriptions, ratings, game content, social media content, photographs, commercial offers, transportation method, weather conditions, or other suitable external content. The first electronic device 100, second electronic device 200, and server 300 can access external content 500 over network 400. External content 500 can be searched by server 300 according to known searching methods and search results can be ranked according to relevance, popularity, or other suitable attributes, including location-specific filtering or promotion.

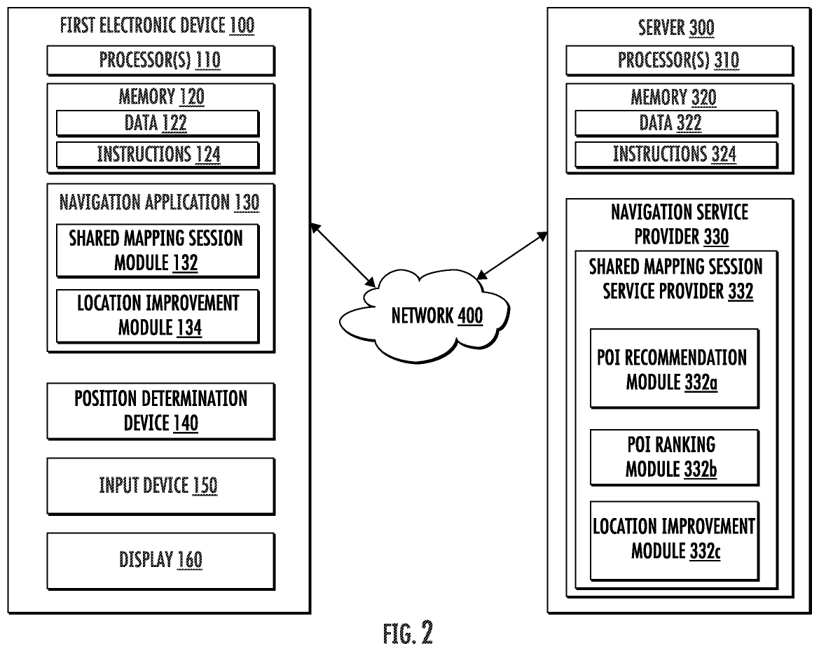

Referring now to FIG. 2, example block diagrams of an electronic device and server according to one or more example embodiments of the disclosure will now be described. Although first electronic device 100 is represented in FIG. 2, features of the first electronic device 100 described herein are also appliable to the second electronic device 200.

The first electronic device 100 may include one or more processors 110, one or more memory devices 120, a navigation application 130, a position determination device 140, an input device 150, and a display 160. The server 300 may include one or more processors 310, one or more memory devices 320, and a navigation service provider 330.

For example, the one or more processors 110, 310 can be any suitable processing device that can be included in a first electronic device 100 or server 300. For example, such a processor 110, 310 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310 can be a single processor or a plurality of processors that are operatively connected, for example in parallel.

The memory 120, 320 can include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, and combinations thereof. However, examples of the memory 120, 320 are not limited to the above description, and the memory 120, 320 may be realized by other various devices and structures as would be understood by those skilled in the art.

For example, memory 120 can store instructions, that when executed, cause the one or more processors 110 to execute a navigation application and initiate a shared mapping session with another electronic device via server 300, as described according to examples of the disclosure. For example, memory 320 can store instructions, that when executed, cause the one or more processors 310 to provide a navigation service including providing a shared mapping session for a plurality of electronic devices, as described according to examples of the disclosure.

Memory 120 can also include data 122 and instructions 124 that can be retrieved, manipulated, created, or stored by the one or more processor(s) 110. In some example embodiments, such data can be accessed and used as input to execute a navigation application and initiate a shared mapping session with another electronic device via server 300, as described according to examples of the disclosure. Memory 320 can also include data 322 and instructions 324 that can be retrieved, manipulated, created, or stored by the one or more processor(s) 310. In some example embodiments, such data can be accessed and used as input to provide a navigation service including providing a shared mapping session for a plurality of electronic devices, as described according to examples of the disclosure.

In some example embodiments, the first electronic device 100 includes a navigation application 130, which may also be referred to as a mapping application. The navigation application 130 can provide navigation services to a user. In some examples, the navigation application 130 can facilitate a user's access to a server 300 that provides navigation services. In some example embodiments, the navigation services include providing directions to a specific location such as a POI. For example, a user can input a destination location (e.g., an address or a name of a POI). In response, the navigation application 130 can, using locally stored map data for a specific geographic area and/or map data provided via the server 300, provide navigation information allowing the user to navigate to the destination location. For example, the navigation information can include turn-by-turn directions from a current location (or a provided origin point or departure location) to the destination location. For example, the navigation information can include a travel time (e.g., estimated or predicted travel time) from a current location (or a provided origin point or departure location) to the destination location.

The navigation application 130 can provide, in a display 160 of the first electronic device 100, a visual depiction of a geographic area. The visual depiction of the geographic area may include one or more streets, one or more points of interest (including buildings, landmarks, and so on), and a highlighted depiction of a planned route. In some examples, the navigation application 130 can also provide location-based search options to identify one or more searchable points of interest within a given geographic area. In some examples, the navigation application 130 can include a local copy of the relevant map data. In other examples, the navigation application 130 may access information at server 300 which may be remotely located, to provide the requested navigation services.

In some examples, the navigation application 130 can be a dedicated application specifically designed to provide navigation services. In other examples, the navigation application 130 can be a general application (e.g., a web browser) and can provide access to a variety of different services including a navigation service via the network 400.

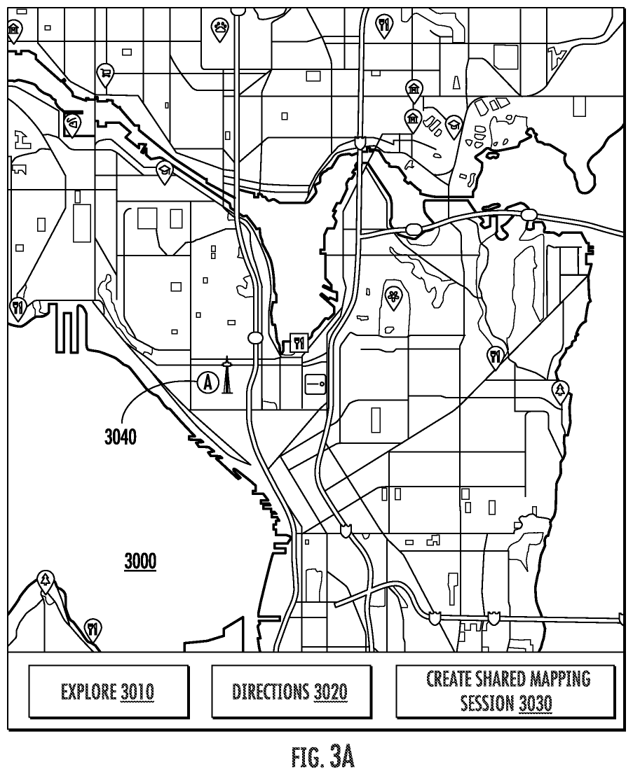

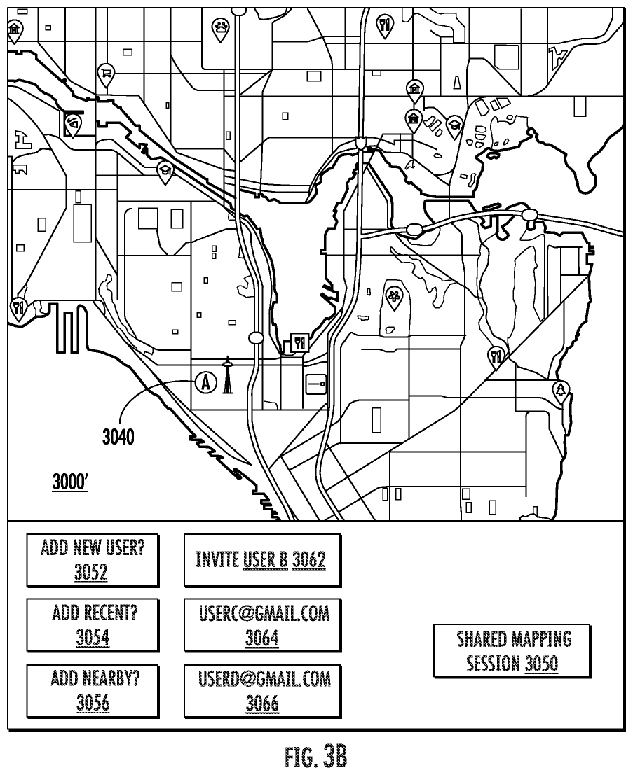

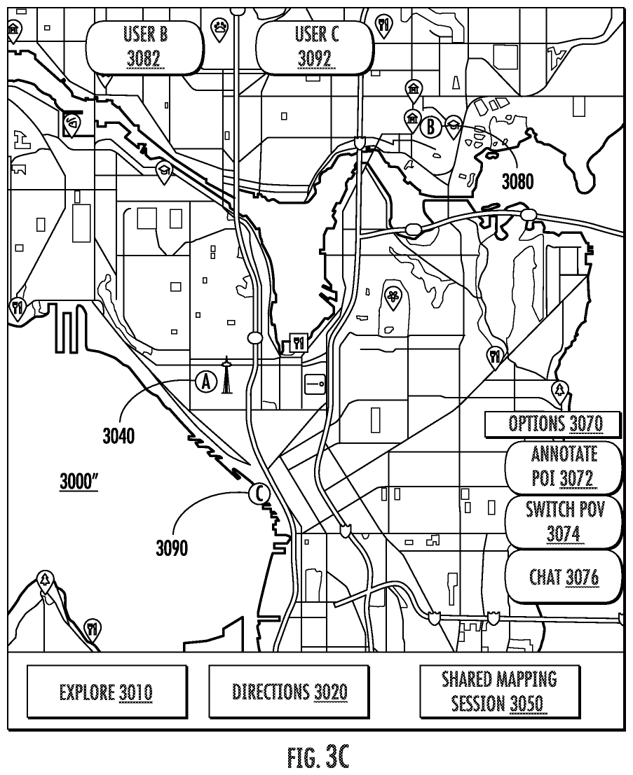

According to one or more aspects of the disclosure, the navigation application 130 can provide a shared mapping session to a user of the first electronic device 100 via a shared mapping session module 132. In some examples, a user can request the initiation of a shared mapping session through the shared mapping session module 132. For example, the shared mapping session may be initiated (e.g., automatically initiated) in response to the navigation application 130 being executed. In some examples, the navigation application 130 can transmit the request to initiate a shared mapping session to the server 300 and/or to other electronic devices. In response, the server 300 may create the shared mapping session. Additional aspects of creating and implementing the shared mapping session will be described with reference to FIGS. 3A-6B.

In some example embodiments, the navigation application 130 also includes a location improvement module 134 to create a joint location stack to provide a more efficient and a more accurate location detection of the first electronic device 100 to allow for an improved navigation mode. For example, using the location improvement module 134 and location information obtained from the position determination device 140, the first electronic device 100 may detect at least one other electronic device (e.g., second electronic device 200) which is in close physical proximity (e.g., within 5 to 10 meters). In response to the first electronic device 100 detecting that at least one of the plurality of electronic devices in the shared mapping session is in close physical proximity to the first electronic device 100, and in response to detecting that at least one electronic device (e.g., the second electronic device 200) has a location accuracy and/or power level below a threshold, the first electronic device 100 may request at least one other electronic device associated with the users in the shared mapping session to provide location information to the second electronic device 200 to form a joint location stack and/or the first electronic device 100 itself may provide location information to the second electronic device 200 to form the joint location stack. In another example, if the first electronic device 100 has a location accuracy and/or power level below a threshold, the first electronic device 100 may request at least one other electronic device associated with the users in the shared mapping session to provide location information to the first electronic device 100 to form a joint location stack. For example, the first electronic device 100 may, in response to determining the first electronic device 100 and the second electronic device 200 are co-located with one another and an accuracy of a location measured by the first electronic device 100 is less than a threshold value, obtain location information from at least one sensor of the second electronic device 200 to create a joint location stack to improve the accuracy of the location measured by the first electronic device 100.

In some example embodiments, the first electronic device 100 includes a position determination device 140. Position determination device 140) can determine a current geographic location of the first electronic device 100 and communicate such geographic location to server 300 over network 400. The position determination device 140 can be any device or circuitry for analyzing the position of the first electronic device 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining a position of the first electronic device 100.

The first electronic device 100 may include an input device 150 configured to receive an input from a user and may include, for example, one or more of a key board (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or voice recognition sensor (e.g., a microphone to receive a voice command), an output sound device (e.g., a speaker), a track ball, a remote controller, a portable (e.g., a cellular or smart) phone, a tablet PC, a pedal or footswitch, a virtual-reality device, and so on. The input device 150 may further include a haptic device to provide haptic feedback to a user. The input device 150 may also be embodied by a touch-sensitive display having a touchscreen capability, for example.

The first electronic device 100 may include a display 160 which displays information viewable by the user (e.g., a map). For example, the display 160 may be a non-touch sensitive display or a touch-sensitive display. The display 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, and the like, for example. However, the disclosure is not limited to these example displays and may include other types of displays. The display 160 may have a square or rectangular shape, or may be annular in shape (e.g., elliptical, circular, etc.). However, the shape of the display 160 is not limited thereto. A user interface for the shared mapping session may be displayed on the display 160. The user interface for the shared mapping session may include information with respect to a plurality of users of respective electronic devices, for example. The display can be used by the navigation application 130 installed on the first electronic device 100 to display navigational information to a user. Navigational information can include, but is not limited to, one or more of a map of a geographic area, the position of the first electronic device 100 in the geographic area, a route through the geographic area designated on the map, one or more navigational directions (e.g., turn-by-turn directions through the geographic area), travel time for the route through the geographic area (e.g., from the position of the first electronic device 100 to a POI), and one or more points-of-interest within the geographic area.

In accordance with example embodiments described herein, the server 300 can include one or more processor(s) 310 and memory 320 which were previously discussed above. The server 300 may also include a navigation service provider 330. For example, the navigation service provider 330 may include a shared mapping session service provider 332 as part of the navigation services provided by the navigation service provider 330. However, the shared mapping session service provider 332 may be separate from the navigation service provider 330.

In some example embodiments, the navigation service provider 330 can provide navigation services to one or more electronic devices (e.g., first and second electronic devices 100, 200) over a network 400. The services provided by the navigation service provider 330 can include location-based services, route generation to a particular location, turn-by-turn navigation instructions, geographic map display services, satellite imagery overlay services, and position tracking services, and other navigational services. Users can submit requests to the server 300, and the navigation service provider 330 can process those requests to provide the requested navigation service. For example, a user of first electronic device 100 can transmit a request for directions to a particular location. In response, the navigation service provider 330 can access navigation data store 390, calculate, based on data in the navigation data store 380, one or more routes to the requested location, and transmit the information describing the one or more routes to the first electronic device 100.

In some example embodiments, a shared mapping session can be generated by the shared mapping session service provider 332 at the server 300 based on a request received from one or more electronic devices. The shared mapping session service provider 332 can provide services for a shared mapping session between a plurality of electronic devices so that users of the electronic devices can have a shared browsing experience when viewing a geographic area using the navigation application 130. For example, the shared mapping session service provider 332 may recommend one or more points-of-interest (POIs) to users of the electronic devices based on inputs provided during the shared mapping session, using the POI recommendation module 332a. For example, in providing a recommendation of one or more POIs, the shared mapping session service provider 332 may rank the points-of-interest based on various inputs provided during the shared mapping session, using the POI ranking module 332b. For example, the shared mapping session service provider 332 may also assist in improving a location accuracy of an electronic device during a shared mapping session when two or more electronic devices in the shared mapping session are co-located. For example, the location improvement module 332c may request location information from a first electronic device in the shared mapping session and provide the location information to a second electronic device in the shared mapping session having a location accuracy below a threshold, so as to improve the location accuracy of the second electronic device. Additional aspects of creating and implementing the shared mapping session via the shared mapping session service provider 332 will be described with reference to FIGS. 3A-6B.

FIGS. 3A-3C include example user interface screens of a user initiating a shared mapping session, according to one or more example embodiments of the disclosure. Referring now to FIG. 3A, illustrated is an example user interface of a navigation application as displayed on a display of an electronic device, according to one or more example embodiments of the disclosure. The example configuration of the user interface shown in FIG. 3A (as well as configurations of the user interfaces illustrated in FIGS. 3B-6B) are not intended to limit the disclosure in any way, and other configurations of the user interface are within the scope of the disclosure. For example, fewer user interface elements or additional user interface elements may be provided on the user interface. The user interface elements may be presented via a pull-down or collapsible menu, for example.

For ease of explanation and for purposes of describing the example embodiments, in FIG. 3A it will be assumed that the user interface 3000 is shown on a display 160 of first electronic device 100. For example, the user interface 3000 may be a user interface of navigation application 130 and include a depiction of a geographic area (e.g., a map) which is associated with a current position 3040 of the user of the first electronic device 100. However, the depiction of the geographic area could be any area that the user is interested in viewing and need not be associated with the current location of the user.

The user interface 3000 may include various user interface elements by which the user may perform various operations to access certain functions of the navigation application 130. For example, in FIG. 3A the user interface 3000 includes user interface elements 3010, 3020, and 3030. For example, user interface element 3010 is labeled “Explore,” and, when selected, can allow a user to perform a search (e.g., via a voice or text input). For example, the user may search for a restaurant, business, hotel, etc., using the user interface element 3010. For example, user interface element 3020 is labeled “Directions,” and, when selected, can allow a user to request directions to a particular location (e.g., via a voice or text input). For example, the user may request directions from their current location to a destination such as a restaurant, business, hotel, etc., using the user interface element 3020, or may request directions from a different departure location to the destination, using the user interface element 3020. For example, user interface element 3030 is labeled “Create Shared Mapping Session,” and, when selected, can allow a user to request that a shared mapping session be created via the shared mapping session module 132.

For example, with reference to FIG. 3B, in response to a selection of user interface element 3030 the shared mapping shared mapping session module 132 may provide a user of the first electronic device 100 with various options to create a shared mapping session 3050 by displaying one or more of user interface elements 3052, 3054, 3056 on the user interface 3000″.

For example, as shown in FIG. 3B, a user may request that a user join the shared mapping session by selecting user interface element 3052 to add a new user. The user of first electronic device 100 may specify a user (e.g., via a text box 3062 or by voice). The user may be identified using, for example, a contact name located in an address book of the user's electronic device, by an email address, by a user ID of an account that is registered with the navigation service provider 330 and/or shared mapping session service provider 332, etc. As another example, the user may request another user to join the shared mapping session by selecting user interface element 3054 to add a user which the shared mapping session service provider 332 and/or shared mapping session module 132 determines as a recent user (e.g., userc@gmail.com 3064) who has participated in a shared mapping session with the user of first electronic device 100. As another example, the user may request another user to join the shared mapping session by selecting user interface element 3056 to add a user which the shared mapping session service provider 332 and/or shared mapping session module 132 determines as a user of an electronic device which is co-located with the first electronic device 100.

Thus, the shared mapping session may be initiated via account sharing via the navigation application 130 and shared mapping session module 132. The user of the first electronic device 100 may specify other users having accounts with the navigation service provider 330 and/or shared mapping session service provider 332, and add those accounts to the shared mapping session (e.g., by specifying a user name associated with the account, an email associated with the account, and the like). As alternative or additional examples, the user of the first electronic device 100 may provide a QR code, a unique link, or other information to a potential participant who is to be added into the shared mapping session. As further alternative or additional examples, the first electronic device 100 may discover or receive a suggestion of a potential participant to join the shared mapping session through wireless protocols including one or more of NFC, Bluetooth, Wifi Direct, Android Nearby and the like. The first electronic device 100 can send, via the shared mapping session module 132, an invitation to the potential participant discovered via the wireless protocol requesting the potential participant to join the shared mapping session.

In some implementations, a user might create a shared mapping session across a plurality of other electronic devices belonging to the user. In this case, the user's known devices might be populated within the navigation application 130 and/or shared mapping session module 132 such that the plurality of other electronic devices can be added to the shared mapping session.

As illustrated in FIG. 3B, to streamline the shared mapping session creation and sharing process, the navigation application 130 and/or shared mapping session module 132 may automatically provide suggestions of potential participants to add once a new session is requested by the user For example, the navigation application 130 and/or shared mapping session module 132 may automatically provide suggestions of potential participants to add in response to discovering nearby users/electronic devices through one or more wireless protocols described herein, based on information received from the server 300, or based on other contextual information (e.g., a contact of the user being co-located with the user and also having the same navigation application active, potential participants sharing a common calendar event, etc.).

According to some implementations, a shared mapping session 3050 may be created based on whether users of the shared mapping session are co-located with one another. In some instances, a shared mapping session 3050 may be created when two or more users of respective electronic devices are physically co-present. For example, User A of the first electronic device 100 and User B of the second electronic device 200 may both be located in a restaurant and using the navigation application 130 to find a movie theater. If User A selects an option to create a shared mapping session, the first electronic device 100 and/or server 300 may automatically transmit invitation information to the second electronic device 200, in response to a determination that the second electronic device is co-located with the first electronic device 100. For example, the shared mapping session 3050 may automatically be initiated between Users A and B. In some implementations, the shared mapping session may automatically be initiated but still require further authentication measures to ensure the users intend to have a shared mapping session 3050. For example, according to examples disclosed herein, any one of the first electronic device 100, second electronic device 200, and server 300 may, in response to determining the first electronic device 100 and the second electronic device 200 are no longer co-located, automatically terminate or delete the shared mapping session 3050. For example, the shared mapping session 3050 may be ended and/or a history of the shared mapping session may be deleted.

In response to receiving an invitation to join a shared mapping session, a potential participant may enter (join) the shared mapping session via various methods. For example, the user may receive a notification on their electronic device via shared mapping session service provider 332 that they have been invited to join a shared mapping session. To join, the user may open a navigation application and join the shared mapping session via the shared mapping session module. As another example, the navigation application may be automatically opened when a user selects to join the shared mapping session when receiving the notification. In some implementations, the shared mapping session service provider 332 may require that a potential participant provide additional authentication factors to confirm that they are authorized to join the shared mapping session. For example, the shared mapping session service provider 332 may require the potential participant to provide additional authentication factors when the session sharing mechanism is less secure (below a first secure sharing mechanism criteria), e.g., via a link-based session sharing mechanism. For example, in some implementations, the shared mapping session service provider 332 may not require the potential participant to provide additional authentication factors when the session sharing mechanism is more secure (above a second secure sharing mechanism criteria), e.g., via an account-based session sharing mechanism.

In some implementations, the authentication factors may be automatically generated prompts based on existing information that exists within the shared mapping session. For example, the server 300 may transmit a query to a joining user requesting confirmation information concerning a context of the session (e.g., a location that is relevant to the shared mapping session). For example, the joining user might be asked “Which city is this session focused on?”. If the joining user correctly provides the answer (e.g., “Paris”) then the server 300 may authorize the user to join. If the joining user does not provide the correct answer, then the server 300 may reject the join request, the joining user may be asked another question, or the joining user may be given another opportunity to correctly respond.

The authentication prompts may also include other confirmation information concerning a context of the session (e.g., names of other participants, such as the initiator or host of the shared mapping session). For example, the server 300 may transmit a query to the joining user such as “What is the name of the owner of this session?”. If the joining user correctly provides the answer (e.g., “John”) then the server 300 may authorize the user to join the shared mapping session. If the joining user does not provide the correct answer, then the server 300 may reject the join request, the joining user may be asked another question, or the joining user may be given another opportunity to correctly respond.

In the above examples, the joining user's input may be fuzzily matched (e.g., by the server 300) against the expected text, for example to allow for variations in spelling or shortened versions. For example, one or more processors 310 of the server 300 may perform fuzzy matching based on text normalization techniques, or via an ML-based model which embeds both the input and the expected value into a common feature space.

In some implementations, as new users are added by the server 300 to the shared mapping session, the server 300 may notify one or more of the existing users in the shared mapping session of the joining event so they are aware of others who join the shared mapping session. For example, the shared mapping session module 132 may provide a message to a user of the first electronic device 100 indicating that another user has joined.

For example, with reference to FIG. 3C, in response to a creation of a shared mapping session between a plurality of electronic devices (e.g., belonging to a plurality of users), the shared mapping session module 132 may generate another user interface 3000″ which provides the user with various options within the shared mapping session 3050. For example, the user interface element 3070 may correspond to a menu of options that are selectable by a user. For example, user interface element 3072 may include an option to annotate a POI, user interface element 3074 may include an option to switch to a point of view of another user within the shared mapping session 3050, and user interface element 3076 may include an option to have a chat with one or more other users within the shared mapping session 3050. The user interface 3000″ may indicate users who are participating in the shared mapping session 3050 by virtue of user interface element 3082 indicating “User B” and by virtue of user interface element 3092 indicating “User C”. In some implementations, a location of an electronic device associated with users participating in the shared mapping session 3050 may be indicated on the map. For example, user interface 3000″ is a user interface as viewed by a user (e.g., User A) of first electronic device 100. In an example, User A may only be able to view their own location in the shared mapping session 3050. As another example, User A may be able to view the location of any electronic device which has joined the shared mapping session 3050, without the need to invoke a separate application for communicating with the one or more other users. As another example, User A may be able to view the location of any electronic device which has given permission for User A (or generally for any user in the shared mapping session) to view the location of their corresponding electronic device in the shared mapping session 3050.

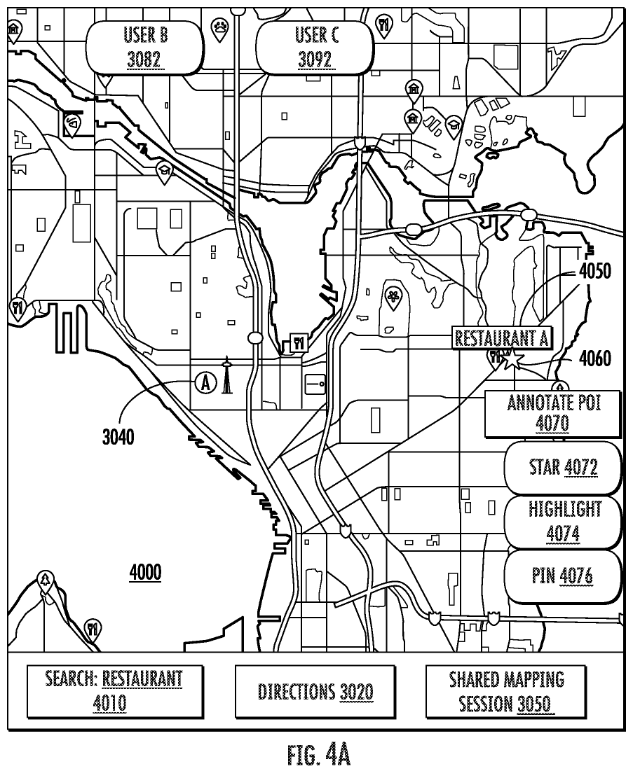

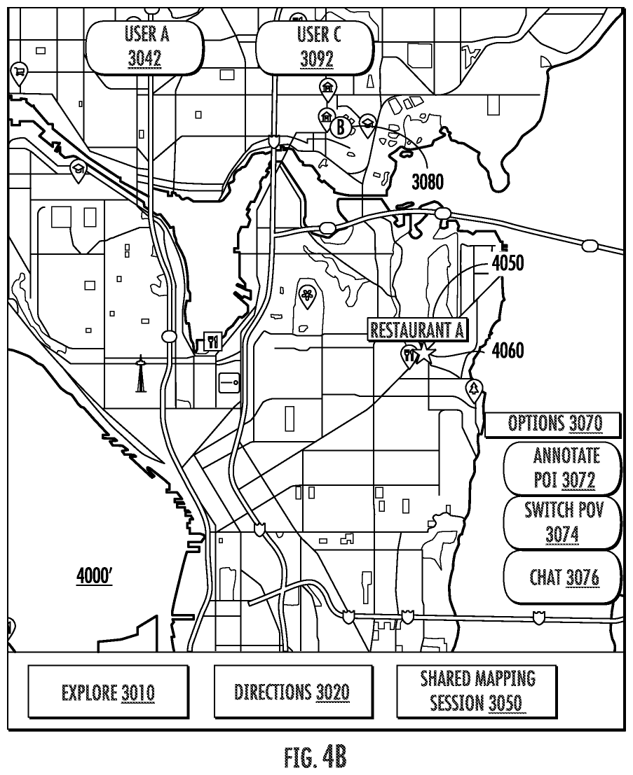

FIGS. 4A and 4B include example user interface screens of a user annotating a point-of-interest which is viewable by another user in a shared mapping session, according to one or more example embodiments of the disclosure. For example, with reference to FIG. 4A, the user interface 4000 illustrates that User A has entered a search for a “Restaurant” via the user interface element 3010 and “Restaurant A” 4060 has appeared as one of the search results on the map. In the shared mapping session 3050 a user may annotate a POI, for example by placing a visual element on the map over or adjacent to the POI, which becomes immediately viewable in real-time to other users in the shared mapping session 3050. For example, in response to selecting the user interface element 3072 to annotate a POI, a new menu may appear on the user interface. For example, a user interface element 4070 may indicate a menu to provide options for annotating the POI. For example, options for annotating the POI may include a user interface element 4072 to annotate the POI with a star, a user interface element 4074 to annotate the POI by highlighting the POI, and a user interface element 4076 to annotate the POI with a pin. For example, in the example user interface 4000, User A has placed a star 4050 adjacent to “Restaurant A” 4060 which is immediately viewable in real-time to other users in the shared mapping session 3050 (e.g., User B and User C as indicated by user interface elements 3082 and 3092, respectively). For example, the annotation may also identify the user who has annotated the POI. For example, in FIG. 4A User A is identified as the user who has annotated Restaurant A 4060 with the star 4050. As another example, the star may be color coded with a color that corresponds to a color associated with the user who has annotated the POI so that other users can readily understand who has annotated the POI.

For example, with reference to FIG. 4B, a user interface 4000′ as displayed on another electronic device to User B is illustrated. For example, the user interface 4000′ illustrates user interface 4000′ immediately after User A has annotated Restaurant A 4060 with the star 4050 on user interface 4000. The user interface 4000′ indicates the position 3080 of User B and indicates that User A and User C are also in the shared mapping session 3050 via user interface elements 3042 and 3092.

Thus, the shared mapping session module 132 is configured to enable a plurality of users to join into a shared mapping session 3050 in the navigation application 130, where each user can indicate a preference for, or interest in, a POI in the shared mapping session 3050 which is immediately visible to other users in the shared mapping session 3050) (e.g., in real-time). For example, a user may indicate an item of interest with respect to a POI by placing a visual element or icon next to or over a location of the POI in the map. For example, the user may place a star on or next to a location of the POI in the map, or drop a pin on or next to a location of the POI in the map. For example, the visual element or icon may be color coded or have some other unique identifier which represents the user, so that other users in the shared mapping session are able to recognize which user has indicated a preference for or interest in the POI.

In an example embodiment, a first user of the first electronic device 100 may indicate a preference for or interest in a first POI by placing a visual element such as a pin next to the first POI in the map. For example, a user may annotate a POI by highlighting or marking specific places and/or routes, and/or may add notes associated with them. This information may be included as part of POI information transmitted to the server 300 from the first electronic device 100 associated with the user and be shared with other users (other electronic devices) in the shared mapping session 3050. For example, the visual element may be made immediately visible to other users in the shared mapping session 3050 via server 300. For example, first electronic device 100 may transmit first POI information to server 300, where the first POI information may include information that the server 300 may use to find a POI that is of interest to the first user, the first POI information may include information about a POI that the first user wishes to share with one or more other users in the shared mapping session, and the like. For example, in response to the first user annotating a POI with a visual element or icon, first POI information which includes the visual element or icon may be transmitted from first electronic device 100 to the server 300. The server 300 may transmit the received first POI information including the visual element or icon to each of the other users in the shared mapping session 3050 so that the visual element or icon is immediately visible to the other users in the shared mapping session 3050 (e.g., in real-time).

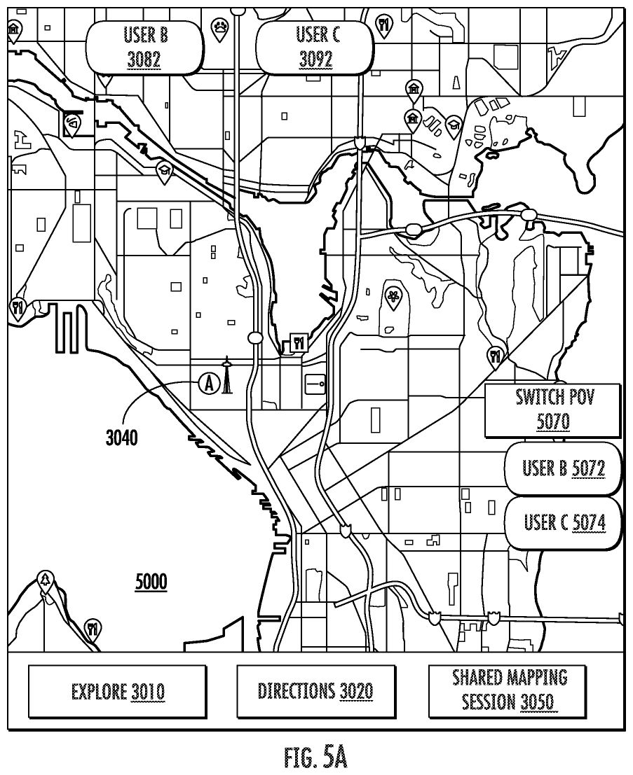

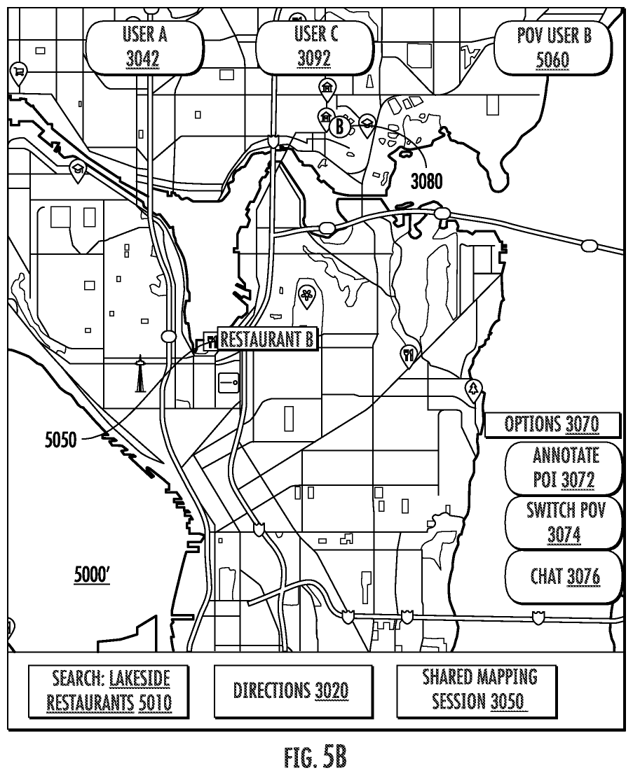

FIGS. 5A and 5B include example user interface screens of a user switching to another user's point of view in a shared mapping session, according to one or more example embodiments of the disclosure. For example, with reference to FIG. 5A, the user interface 5000 illustrates a user interface which may be displayed in response to a user selecting the user interface element 3074 to switch to another user's point of view in the shared mapping session 3050. For example, a user interface element 5070 may indicate a menu to provide options for selecting a user in the shared mapping session which the user is able to switch to. For example, users who may be switched to may be users who have given their permission for other users in the shared mapping session to select. For example, User A of the first electronic device 100 may switch to a point of view of User B by selecting user interface element 5072 and may switch to a point of view of User C by selecting user interface element 5074.

For example, reference to FIG. 5B illustrates a user interface 5000′ as displayed on first electronic device 100 to User A in response to User A selecting user interface element 5072, where the user interface 5000′ displays the user interface as displayed to User B in the shared mapping session 3050. For example, the user interface 5000′ illustrates the real-time user interface of User B which reflects that User B has conducted a search for “Lakeside restaurants” in a search box 5010, with a search result showing Restaurant B 5050 on the map. To avoid possible confusion for User A, an indication 5060 may be presented on user interface 5000′ that the user interface is displaying another user's point-of-view (e.g., “POV USER B”). The indication 5060 may be selectable for User A to exit out of the point-of-view option and return to user interface 5000.

Thus, according to one or more examples of the disclosure, a user may switch or snap to another user's viewpoint to enable a shared viewing experience. For example, if a second user (e.g., User B) is browsing a particular area in Seattle, then a first user (e.g., User A) can select an option to switch to another user's point of view through user interface element 5072 within the shared mapping session 3050 to immediately hop to the second user's point of view in the shared mapping session 3050, at the location on the map where the second user is viewing. According to an example of the disclosure, the server 300 may receive a request from the first electronic device 100 to provide a real-time map view of the shared mapping session 3050 from a point of view of a second user of a second electronic device 200. In response to receiving the request the server 300 may transmit the real-time map view of the shared mapping session 3050 from the point of view of the second user as displayed on the second electronic device 200, to the first electronic device 100.

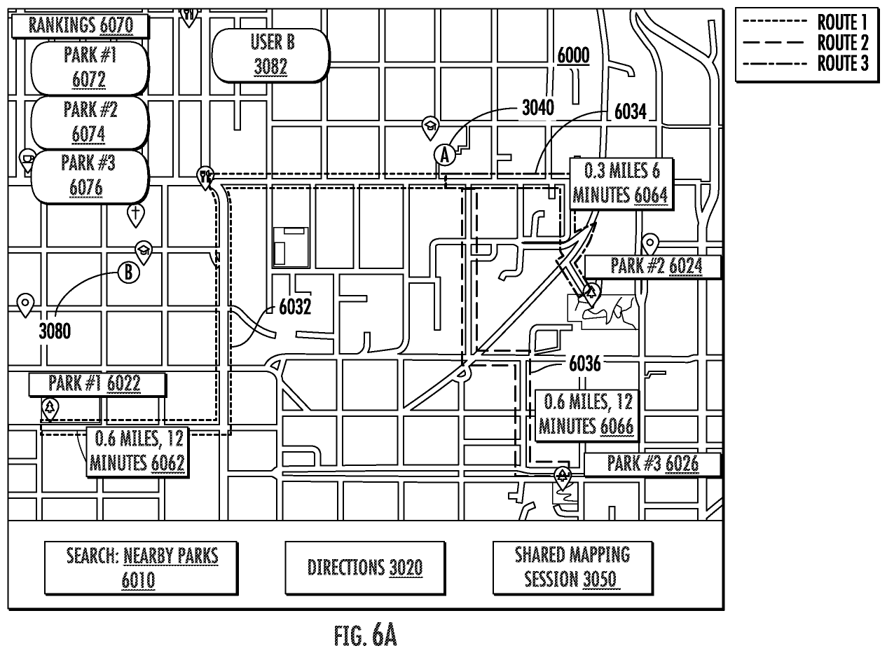

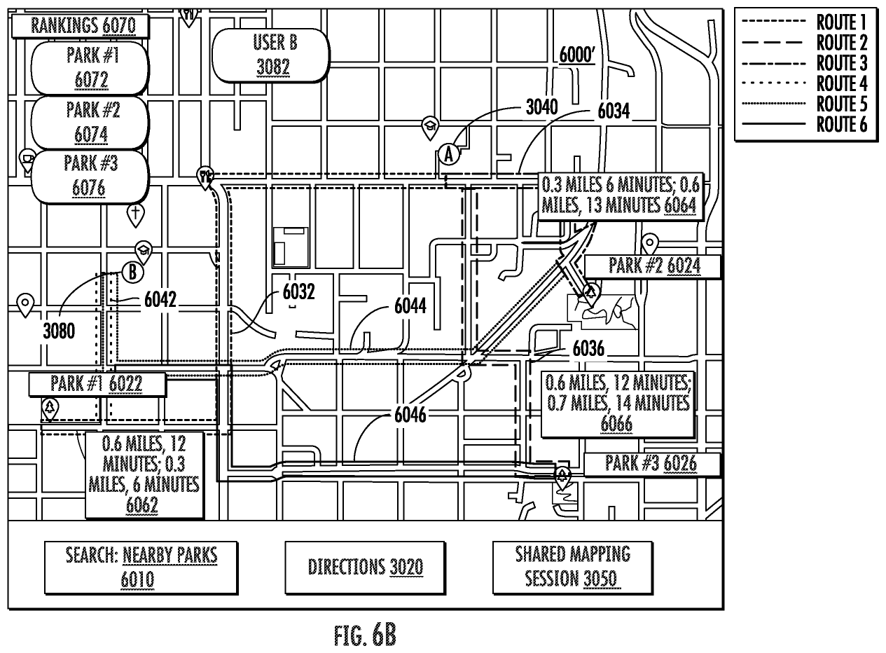

FIGS. 6A and 6B include example user interface screens displaying navigation information to ranked recommended points-of-interest, according to one or more example embodiments of the disclosure.

For example, FIG. 6A illustrates an example user interface 6000 which may be displayed in response to User A of the first electronic device 100 performing a search for “Nearby Parks” via a search text box (or by voice input for example) with respect to the user interface element 6010, during a shared mapping session 3050. In this example embodiment positions 3040, 3080 of Users A and B are also displayed in the shared mapping session 3050. User A's search query may be transmitted to server 300. The content of the search query may be considered as first POI information. For example, first POI information may also include information about User A, for example, information stored in a user profile of User A, such as a preference for parks which allow dogs. First position information about User A may also be transmitted to server 300. The first position information may include a current location of User A (at a school) as a departure location or another location that User A specifies as the departure location (e.g., User A's home).

As part of the shared mapping session 3050, in generating search results the server 300 also considers User B's departure location (second position information) and User B's input regarding the POI (second POI information), as applicable (e.g., User B's preferences with respect to parks, User B's preferences with respect to maximum travel time, mode of travel, etc.). For example, the shared mapping session service provider 332 may be configured to perform a search based on the first position information, first POI information, second position information, and second POI information. The server 300 may generate search results, for example by referencing information stored in one or more of the POI data store 370, navigation data store 380, and user data store 390. The POI ranking module 332b may rank the search results according to a group-based result ranking system, and POI recommendation module 332a may recommend one or more of the POIs to the users in the shared mapping session 3050. For example, in FIG. 6A, server 300 has transmitted search results to the first electronic device 100 which include a plurality of nearby parks (Park #1 6022, Park #2 6024, and Park #6026) that are identified on the map (e.g., by highlighting, by a label with the name of the park, etc.). These search results may also be transmitted to the second electronic device 200 and displayed on the user interface in the shared mapping session as viewed by User B of the second electronic device 200. For example, in FIG. 6A, server 300 has transmitted first navigation information to the first electronic device 100 which includes routes 6032, 6034, 6036 and travel information 6062, 6064, 6066 to the plurality of parks. For example, the travel information 6062, 6064, 6066 may include a length of the route and/or a travel time of the route. The search results may be ranked by server 300 and transmitted to each of the electronic devices in the shared mapping session 3050. For example, in FIG. 6A user interface element 6070 displays the rankings of the search results and user interface elements 6072, 6074, 6076 indicate Park #1 is ranked first, Park #2 is ranked second, and Park #3 is ranked third.

Thus, according to examples of the disclosure, the server 300 may receive first position information associated with a first user (e.g. User A) in the shared mapping session 3050 and position information associated with other users (e.g., User B) who have joined the shared mapping session 3050 (e.g., second position information associated with User B). The shared mapping session service provider 332 may be configured to use the position information of each of the users to determine a common meeting point (i.e., a point-of-interest) for the users. For example, the position information may indicate a current geographic location of the electronic device of a user which executes the navigation application with the shared mapping session (e.g., based on a GPS signal, or a location determined based on a wireless network). For example, the position information may indicate a planned geographic location of a planned departure location of the user (e.g., a geographic location of a user's home, workplace, or other location), which may be based on an address, world coordinate system, or other location information that may be publicly available. Each of the users may be traveling from a different source location or origin point (e.g., their respective home or work locations). To find a suitable common meeting point, each user in the shared mapping session 3050 can provide their own origin (departure) point. For example, when a user joins the shared mapping session 3050, the server 300 may receive a location (origin or planned departure point) of the user (e.g., a current location of the electronic device being used by the user, or of a planned departure location). The location of the electronic device of a user may be provided automatically to the server 300 upon joining the shared mapping session, or the user may be prompted by the server 300 when joining the shared mapping session to provide their origin point or departure location. In some implementations the departure location of a user may be automatically shared with other users via the shared mapping session 3050, while in other implementations the departure location of a user may be shared with only authorized users via the shared mapping session 3050, or the departure location of the user may not be shared with other users at all.

According to examples of the disclosure, the server 300 may receive first POI information associated with a first user (e.g. User A) in the shared mapping session 3050 and POI information associated with other users (e.g., User B) who have joined the shared mapping session 3050 (e.g., second POI information associated with User B). For example, the POI information may include a preferred mode of transit of the user (e.g., car, bus, train, etc.).

The POI recommendation module 332a may be configured to use the position information of the users and the received POI information to determine one or more recommended POIs to be offered to the users in the shared mapping session 3050. According to an example of the disclosure, the POI recommendation module 332a may be configured to determine, based at least in part on first position information of a first user, second position information of a second user, first POI information, and second POI information, one or more recommended POIs. Thus, users in the shared mapping session 3050 may obtain recommendations from the server 300 for one or more POIs based on one or more queries sent to the server 300 from one or more users in the shared mapping session 3050. The POI recommendation module 332a may determine the one or more recommended POIs based on various criteria (POI information such as the search term “restaurant”, user profile information, if shared, of one or more of the users in the shared mapping session 3050, travel restrictions of one or more users in the shared mapping session, etc.). According to an example of the disclosure, the server 300 is configured to transmit the one or more recommended POIs to the first electronic device 100 and to other users (e.g., second electronic device 200) in the shared mapping session such that the one or more recommended POIs are viewable (e.g., simultaneously viewable) to the first user and the other users (e.g., the second user) in the shared mapping session 3050.

For example, the one or more recommended POIs may be determined by the POI recommendation module 332a according to a ranking mechanism performed by POI ranking module 332b. Any one of the users may perform a query or request for suggestions or recommendations via the shared mapping session 3050. In the context of a shared mapping session, these results can be ranked by POI ranking module 332b based on the POI information received by the server from users in the shared mapping session 3050. Ranking of the POIs can help ensure that a recommended POI is relevant to most if not all of the users in the shared mapping session 3050) (e.g., to ensure that the type of restaurant would be of interest to all participants), and also to ensure that a recommended POI can be easily accessed from the origin point or departure location of the users in the shared mapping session.

For example, the POI ranking module 332b may be configured to collectively rank POIs based on all users in the shared mapping session. For example. POI ranking module 332b may be configured to rank POIs by extending current ranking mechanisms to jointly score a candidate POI with respect to each user and come up with an average (or other aggregate) score. The results may be sorted by the POI ranking module 332b based on the aggregate scores and the user interface of an electronic device in the shared mapping session may display the top results to the users (e.g., via one or more of user interface elements 6070), 6072, 6074, 6076) in the shared mapping session 3050. An example input for ranking a candidate POI may include respective travel times for each of the users in the shared mapping session 3050. For example, the POI ranking module 332b may be configured to exclude candidate POIs which exceed a specified travel time for any one of the users as possible recommended POIs and the POI ranking module 332b may incorporate this into the ranking signal. POI ranking module 332b may be configured to give greater weight to candidate POIs with a shorter average travel time for all of the users in the shared mapping session (e.g., less than a first threshold value) than candidate POIs with a longer travel time (e.g., greater than the first threshold value, or greater than a second threshold value which is greater than the first threshold value). Accordingly, the one or more recommended POIs suggested by the shared mapping session service provider 332 may have an expected travel time that is not too high for any one user.

In conjunction with determining one or more recommended POIs, the shared mapping session service provider 332 may also be configured to determine navigation information (e.g., directions, travel time, alternate routes, etc.) to the one or more recommended POIs from each of the origin or departure locations of each of the users in the shared mapping session 3050. The shared mapping session service provider 332 may also be configured to transmit navigation information to respective users so that each user can view the navigation information from their respective origin point or departure location to the one or more recommended POIs (e.g., as shown in FIG. 6A in which the user interface 6000 displays navigation information from the position 3040 of User A to three recommended POIs (Park #1 6022, Park #2 6024, Park #3 6026). Navigation information to a recommended POI may be distinguished from navigation information to other recommended POIs, for example, by the use of color, by using different markings for the travel route and/or travel time, or combinations thereof. According to an example of the disclosure, the shared mapping session service provider 332 may be configured to transmit first navigation information to the first electronic device 100, the first navigation information indicating travel information from a location associated with the first user to a location of the one or more recommended POIs such that at least one of a travel time or a travel route from the location associated with the first user to the location of the one or more recommended POIs is viewable to the first user in the shared mapping session. According to an example of the disclosure, the shared mapping session service provider 332 may be configured to transmit navigation information to other users, such as second navigation information to a second user of the second electronic device 200. The second navigation information may indicate travel information from a location associated with the second user (e.g., from the position 3080 of User B) to a location of the one or more recommended POIs such that at least one of a travel time or a travel route from the location associated with the second user to the location of the one or more recommended POIs is viewable to the second user in the shared mapping session 3050.

For example, FIG. 6B illustrates an example user interface 6000′ which may be displayed in response to User A of the first electronic device 100 performing a search for “Nearby Parks” via a search text box (or by voice input for example) with respect to the user interface element 6010, during a shared mapping session 3050. In this example embodiment positions 3040, 3080 of Users A and B are also displayed in the shared mapping session 3050. In addition, in this example embodiment navigation information with respect to User B as well as with respect to User A is displayed on the user interface 6000′. For example, in FIG. 6B, server 300 has transmitted second navigation information to the first electronic device 100 which includes routes 6042, 6044, 6046 to the plurality of parks from the origin point or departure location of User B. For example, in FIG. 6B the travel information 6062, 6064, 6066 may include a length of the route and/or a travel time of the route with respect to each of Users A and B. Accordingly, User A is able to view in the shared mapping session the navigation information with respect to User B and with respect to each of the recommended POIs.

Thus, in some implementations, the shared mapping session service provider 332 may be configured to transmit navigation information of other users (e.g. a second user) to the first user, such that at least one of a travel time or a travel route from the location associated with the other users (e.g., the second user) to the location of one or more recommended POIs is viewable to the first user in the shared mapping session 3050. The navigation information of the other users may be viewable simultaneously with at least one of a travel time or a travel route from the location associated with the first user to the location of the one or more recommended POIs. That is, in some implementations a user may be able to view travel routes and/or travel times from origin points or departure locations of other users to a selected or recommended point-of-interest. Thus, a user can quickly ascertain travel information (e.g., directions and/or travel times) to the selected or recommended point-of-interest from origin points or departure locations of other users to the selected or recommended point-of-interest (as well as travel information from their own origin point or departure location to the selected or recommended point-of-interest). Accordingly, users in the shared mapping session 3050) can gain a better understanding of the travel information of the other users in determining whether the selected or recommended point-of-interest is acceptable in terms of travel convenience. For example, ease of accessibility of recommendations of points-of-interest can be identified through color-coding or other means (e.g., representing POIs which are easily accessible with the color green, POIs which are least accessible with the color red, and POIs which are of moderate accessibility with the color yellow).

In some implementations, the shared mapping session service provider 332 may be configured to transmit navigation information to a user in response to a request from the user for navigation information to a point-of-interest, independently of a recommendation to be generated by the POI recommendation module 332a. For example, navigation information may be transmitted to a first user in response to the shared mapping session service provider 332 receiving a request from the first user and/or the second user for directions to a POI that is selected by the first user and/or the second user. For example, the shared mapping session service provider 332 may determine and transmit directions to a POI given a plurality of origin points corresponding to a plurality of users in the shared mapping session 3050. Similar to the example of FIG. 6B a user may also receive navigation information of other users in the shared mapping session 3050 to the POI. Thus, each user can quickly ascertain travel information to the POI from their respective origin point or departure location (and in some examples to the POI from one or more origin points or departure locations of one or more other users in the shared mapping session 3050) and determine whether the POI is acceptable in terms of travel. This allows each of the users to easily find a POI which can be reached by all of the users in a single step. For example, in the shared mapping session 3050 each user can indicate whether the POI is at an acceptable location (e.g., by a voting mechanism within the shared mapping session 3050, by providing a “thumbs-up” indication within the shared mapping session, or by providing some other indication or visual element within the shared mapping session (e.g., a heart, a star, happy face, etc.).

In some examples, although a navigation application 130 may be closed by a user, the shared mapping session module 132 and/or shared mapping session service provider 332 may be configured to keep the shared mapping session 3050 active. For example, if a user reopens the navigation application 130, the user may be able to view a list of active shared mapping sessions on a user interface of the navigation application 130. The user may select one of the shared mapping sessions from the list to switch into that shared mapping session again. The list of shared mapping sessions may be ranked based on various factors, such as based on recency, the user's current location, if other users from the shared mapping session are co-located with the user, etc. In some implementations, a shared mapping session may be sticky, i.e., the user may automatically join the shared mapping session 3050) upon reopening the navigation application 130. A sticky shared mapping session may be useful in instances where the shared mapping session exists for a plurality of electronic devices belonging to a same user. That is, the user may switch back into a shared mapping session even when using a different electronic device.

Shared mapping sessions may remain active indefinitely, or may automatically terminate (e.g., after inactivity lasting longer than a predetermined duration of time such as a few minutes, a few hours, a few days, etc.). If the shared mapping session was initiated by two or more users who were co-located, then the shared mapping session may be terminated when the users are no longer co-located. Additionally or alternatively, a user may explicitly terminate or delete a shared mapping session after it is no longer required, for example by selecting a shared mapping session to delete through a user interface of the shared mapping session 3050, or an option to delete the shared mapping session 3050 may be displayed to the user on the user interface upon exiting the shared mapping session 3050 and/or exiting the navigation application 130.

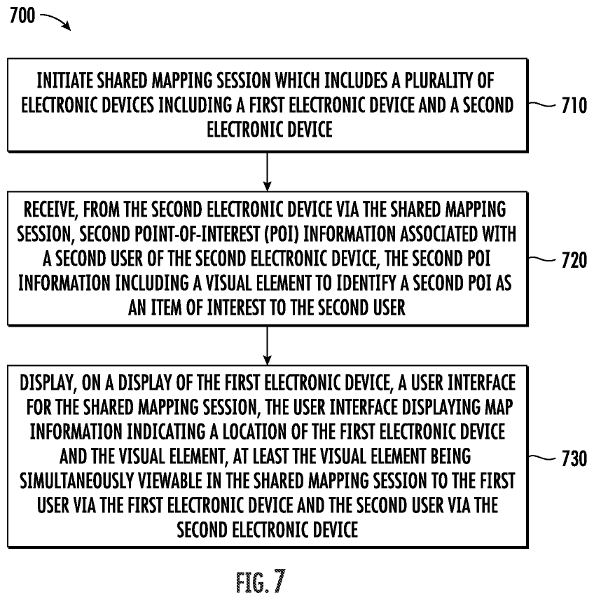

Examples of the disclosure are also directed to computer implemented methods of a shared mapping session. FIGS. 7-11 include flow diagrams of example, non-limiting computer-implemented methods according to one or more example embodiments of the disclosure.

Referring to FIG. 7, in an example computer implemented method at operation 710 the method includes initiating the shared mapping session 3050 which includes a plurality of electronic devices including a first electronic device 100 and a second electronic device 200. At operation 720 the method includes receiving, from the second electronic device 200 via the shared mapping session 3050, second point-of-interest (POI) information associated with a second user of the second electronic device 200, the second POI information including a visual element (e.g., visual element 4060) to identify a second POI (e.g., “Restaurant A” 4050) as an item of interest to the second user. For example, the second POI information may include user profile information about the second user. For example, the visual element may include a star or pin that the second user has placed next to or over a POI displayed on a map that is of interest to the second user in the shared mapping session.

At operation 730 the method may include displaying, on a display 160 of the first electronic device 100, a user interface (e.g., similar to user interface 4000′) for the shared mapping session 3050, the user interface displaying map information indicating a location of the first electronic device 100 and the visual element, at least the visual element being simultaneously viewable in the shared mapping session 3050 to the first user via the first electronic device 100 and the second user via the second electronic device 200.

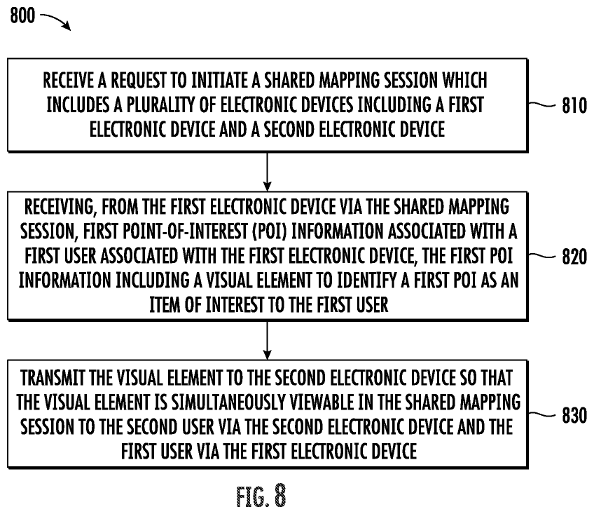

Referring to FIG. 8, in an example computer implemented method 800 at operation 810 the method includes receiving (e.g., by server 300) a request to initiate a shared mapping session 3050 which includes a plurality of electronic devices including a first electronic device 100 and a second electronic device 200. At operation 820 the method includes receiving (e.g., by server 300), from the first electronic device 100 via the shared mapping session 3050, first point-of-interest (POI) information associated with a first user associated with the first electronic device 100, the first POI information including a visual element to identify a first POI as an item of interest to the first user. At operation 830 the method includes transmitting (e.g., by server 300) the visual element to the second electronic device 200 so that the visual element is simultaneously viewable in the shared mapping session 3050 to the second user via the second electronic device 200 and the first user via the first electronic device 100.

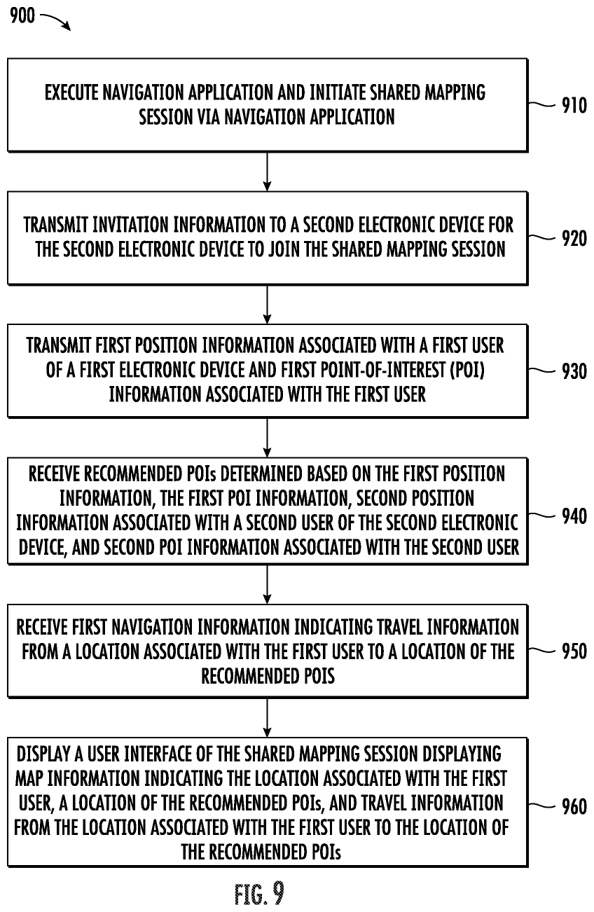

Referring to FIG. 9, in an example computer implemented method 900 at operation 910 the method includes executing a navigation application 130 and initiating a shared mapping session 3050 via the navigation application 130 (e.g., via the shared mapping session module 132). At operation 920 the method further includes transmitting invitation information to a second electronic device 200 for the second electronic device 200 to join the shared mapping session 3050. At operation 930 the method further includes transmitting first position information associated with a first user of a first electronic device 100 and first point-of-interest (POI) information associated with the first user. At operation 940 the method further includes receiving one or more recommended POIs determined (e.g., by a server) based on the first position information, the first POI information, second position information associated with a second user of the second electronic device, and second POI information associated with the second user. At operation 950 the method further includes receiving first navigation information indicating travel information from a location associated with the first user of the first electronic device 100 (e.g., a current location of the first user based on a current location of the first electronic device 100 or a planned departure location) to a location of the recommended POIs. At operation 960 the method further includes displaying a user interface of the shared mapping session which displays map information indicating the location associated with the first user, a location of the recommended POIs, and travel information from the location associated with the first user to the location of the one or more recommended POIs.

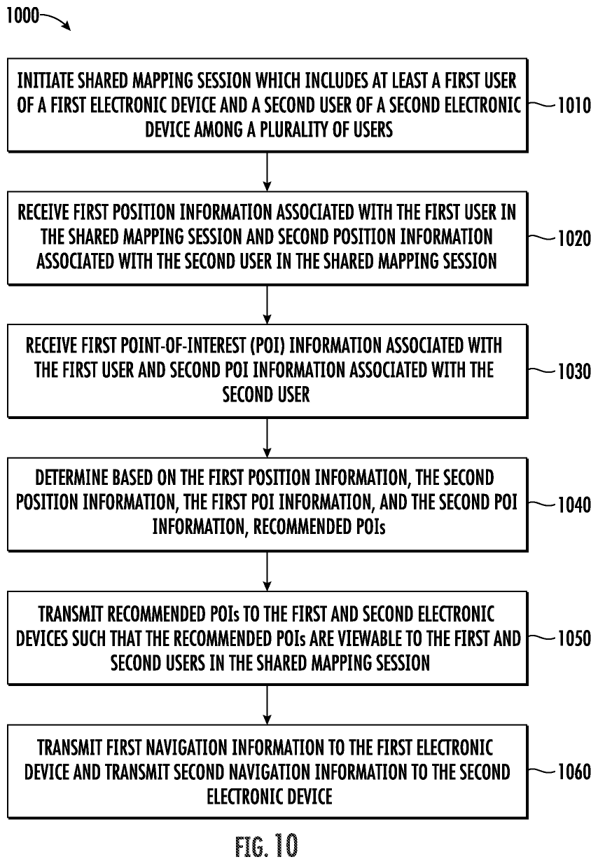

Referring to FIG. 10, in an example computer implemented method 1000 at operation 1010 the method includes initiating (e.g., by server 300) a shared mapping session 3050 which includes at least a first user of a first electronic device 100 and a second user of a second electronic device 200 among a plurality of users. At operation 1020 the method includes receiving (e.g., by server 300) first position information associated with the first user in the shared mapping session 3050) and second position information associated with the second user in the shared mapping session 3050. At operation 1030 the method includes receiving (e.g., by server 300) first point-of-interest (POI) information associated with the first user and second POI information associated with the second user. At operations 1040 and 1050 the method includes determining (e.g., by server 300), based on the first position information, the second position information, the first POI information, and the second POI information, one or more recommended POIs and transmitting the one or more recommended POIs to the first and second electronic devices 100, 200 such that the recommended POIs are simultaneously viewable to the first and second users of the first and second electronic devices 100, 200 in the shared mapping session 3050. At operation 1060 the method includes transmitting (e.g., by server 300) first navigation information to the first electronic device 100 and transmitting second navigation information to the second electronic device 200. In another example, the second navigation information may also be transmitted to the first electronic device 100, and the first navigation information may also be transmitted to the second electronic device 200.

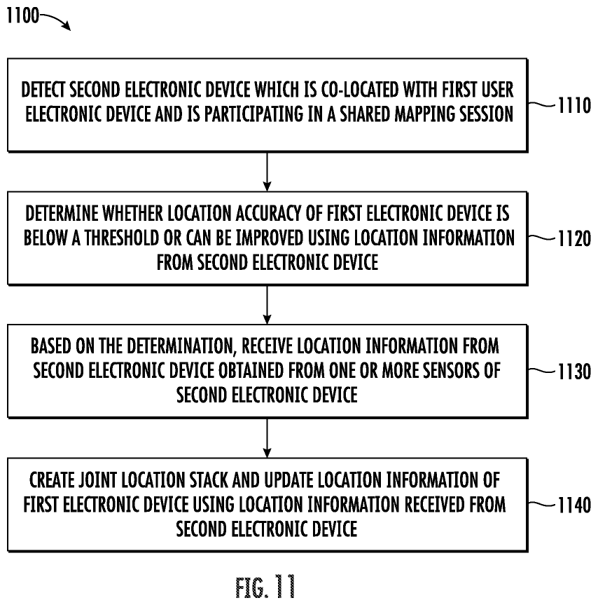

Referring to FIG. 11, in an example computer implemented method 1100 at operation 1110 the method includes detecting (e.g., by first electronic device 100 and/or server 300) a second electronic device 200 which is co-located with first user electronic device 100 and is participating in a shared mapping session 3050 with the first electronic device 100. At operation 1120 the method includes determining (e.g., by the first electronic device and/or server 300) whether a location accuracy of the first electronic device 100 is below a threshold or can be improved using location information from another electronic device in the shared mapping session (e.g., second electronic device 200). At operation 1130 the method includes based on the determination, receiving (e.g., by the first electronic device and/or server 300) location information from the second electronic device 200 obtained from one or more sensors (e.g., a position determination device) of second electronic device 200. For example, if the server 300 and/or first electronic device 100 determines the location accuracy of the first electronic device 100 is below the threshold and/or can be improved using the location information from another electronic device in the shared mapping session, then the server 300 and/or first electronic device 100 may request and obtain location information from one or more sensors of the second electronic device 200 (e.g., via the server 300 or directly from the second electronic device 200). At operation 1130 the method includes creating a joint location stack and updating location information of first electronic device 100 using location information received from the second electronic device 200, to improve the location accuracy of the first electronic device 100.

For example, in some implementations the current location of the first electronic device 100 may be represented by a blue dot on the map displayed in the user interface. A location accuracy of the first electronic device 100 may be indicated by one or more of a size of the blue dot (e.g., a smaller circumference indicating a more precise location determination), a size of an outer light-blue circle surrounding the blue dot, and a stability of the blue dot (e.g., shifting of the blue dot may indicate uncertainty about the location of the electronic device). For example, when the size of the blue dot is greater than a threshold value, the server 300 and/or first electronic device 100 may request and obtain location information from one or more sensors of the second electronic device 200. For example, when the circumference of the outer light-blue ring is greater than a threshold value, the server 300 and/or first electronic device 100 may request and obtain location information from one or more sensors of the second electronic device 200. For example, when the blue dot does not remain steady at a particular location for more than a predetermined period of time, the server 300 and/or first electronic device 100 may request and obtain location information from one or more sensors of the second electronic device 200.

Thus, according to examples of the disclosure, a shared mapping session 3050) between electronic devices of the shared mapping session 3050 who are co-located with one another may additionally allow for the sharing of sensors (e.g., one or more sensors of the position determination device 140) from their respective electronic devices. That is, when a plurality of electronic devices in the shared mapping session 3050 are detected to be in close physical proximity to one another, the shared mapping session 3050 can create a joint location stack to provide more efficient and more accurate location detection, e.g., to show a more accurate blue dot on the map, or to allow for an improved navigation mode. In an example, the server 300 may detect that the plurality of users in the shared mapping session are in close physical proximity to one another based on position information of the first and second electronic devices 100, 200 being provided to the server 300. Additionally, or alternatively, one of the electronic devices of a user may detect at least one other electronic device (e.g., belonging to another user) which is in close physical proximity. In response to the server 300 detecting that the plurality of users in the shared mapping session are in close physical proximity to one another, and in response to detecting that at least one electronic device (e.g., the first electronic device 100) has a location accuracy and/or power level below a threshold, the server 300 may request at least one other electronic device associated with the users in the shared mapping session to provide location information to the first electronic device 100 to form a joint location stack. Additionally, or alternatively, in response to a first electronic device 100 detecting that the plurality of electronic devices in the shared mapping session are in close physical proximity to one another, and in response to detecting that the first electronic device 100 itself has a location accuracy and/or power level below a threshold, the first electronic device 100 may request at least one other electronic device associated with the users in the shared mapping session to provide location information to the first electronic device 100 to form a joint location stack. For example, according to the method 1100 disclosed herein, the first electronic device 100 may, in response to determining the first electronic device 100 and a second electronic device 200 are co-located with one another and an accuracy of a location measured by the first electronic device 100 is less than a threshold value, obtain location information from at least one sensor of the second electronic device 200 to create a joint location stack to improve the accuracy of the location measured by the first electronic device 100.

For example, one user's electronic device might provide GPS capabilities for others, e.g., if it has more power or a more accurate sensor reading, or if another user's electronic device has low power or a low accurate sensor reading. More generally, various sensors from different devices which are capable of determining a position of the electronic device (e.g., a GPS disposed in the first electronic device 100, a WiFi/cell disposed in a second electronic device 200, a camera disposed in a further device) may be combined to produce a single, more accurate location measurement (e.g., a joint location stack). In another example, a joint location stack may be constructed from two or more electronic devices that are all owned by the same user. For example, a user might pair their watch and phone together to collaboratively provide a higher accuracy location signal whenever the two devices are in close proximity.

The terms “module”, and “unit,” as used herein (e.g., in connection with the shared mapping session module 132, location improvement module 134, POI recommendation module 332a, POI ranking module 332b, and location improvement module 332c), may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape: optical media such as CD ROM disks, Blue-Ray disks, and DVDs: magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computer-implemented method for a shared mapping session, the method comprising:
initiating the shared mapping session which includes a plurality of electronic devices including a first electronic device having a first user and a second electronic device having a second user;
receiving, from the second electronic device via the shared mapping session, second point-of-interest (POI) information associated with the second user, the second POI information including a visual element to identify a second POI as an item of interest to the second user; and
displaying, on a display of the first electronic device, a user interface for the shared mapping session, the user interface displaying map information indicating the visual element and a location associated with the first user, at least the visual element being simultaneously viewable in the shared mapping session to the first user via the first electronic device and the second user via the second electronic device.

2. The computer-implemented method of claim 1, further comprising:
transmitting a request for a real-time map view of the shared mapping session from a point of view of the second user of the second electronic device;
receiving the real-time map view of the shared mapping session from the point of view of the second user of the second electronic device; and
displaying in the user interface of the shared mapping session the real-time map view of the shared mapping session from the point of view of the second user of the second electronic device.

3. The computer-implemented method of claim 1, further comprising:
receiving second navigation information indicating travel information from a departure location of the second user to a location of the second POI; and
based on the second navigation information, displaying in the user interface of the shared mapping session at least one of a travel time or a travel route from the departure location of the second user to the location of the second POI, simultaneously with at least one of a travel time or a travel route from a departure location of the first user to the location of the second POI.

4. The computer-implemented method of claim 1, further comprising:
transmitting, to a server, first position information associated with the first user of the first electronic device and first point-of-interest (POI) information associated with the first user;
receiving, from the server, one or more recommended POIs determined by the server based at least in part on the first position information, the first POI information, second position information associated with the second user, and the second POI information;
displaying in the user interface of the shared mapping session at least one of a travel time or a travel route from a departure location of the first user to the location of the one or more recommended POIs; and
displaying in the user interface of the shared mapping session a location of the one or more recommended POIs that is simultaneously viewable in the shared mapping session to the second user via the second electronic device.

5. The computer-implemented method of claim 1, further comprising:
in response to determining the first electronic device is co-located with the second electronic device, automatically transmitting invitation information to the second electronic device to join the shared mapping session; and
in response to determining the first electronic device and the second electronic device are no longer co-located, automatically terminating the shared mapping session.

6. The computer-implemented method of claim 1, further comprising:
in response to determining the first electronic device and the second electronic device are co-located with one another and an accuracy of a location measured by the first electronic device is less than a threshold value, obtaining location information from at least one sensor of the second electronic device to improve the accuracy of the location measured by the first electronic device.

7. An electronic device, comprising:
a display;
one or more memories configured to store instructions; and
one or more processors configured to execute the instructions stored in the one or more memories to:
initiate a shared mapping session which includes a plurality of electronic devices including the electronic device having a first user and a second electronic device having a second user,
receive, from the second electronic device via the shared mapping session, second point-of-interest (POI) information associated with the second user, the second POI information including a visual element to identify a second POI as an item of interest to the second user, and
display, on the display, a user interface for the shared mapping session, the user interface displaying map information indicating a location associated with the first user, at least the visual element being simultaneously viewable in the shared mapping session to the first user via the electronic device and the second user via the second electronic device.

8. The electronic device of claim 7, wherein the one or more processors are configured to:
transmit a request for a real-time map view of the shared mapping session from a point of view of the second user of the second electronic device,
receive the real-time map view of the shared mapping session from the point of view of the second user of the second electronic device, and
display in the user interface of the shared mapping session the real-time map view of the shared mapping session from the point of view of the second user of the second electronic device.

9. The electronic device of claim 7, wherein the one or more processors are configured to:
receive second navigation information indicating travel information from a departure location of the second user to a location of the second POI, and
based on the second navigation information, display in the user interface of the shared mapping session at least one of a travel time or a travel route from the departure location of the second user to the location of the second POI, simultaneously with at least one of a travel time or a travel route from a departure location of the first user to the location of the second POI.

10. The electronic device of claim 7, wherein the one or more processors are configured to:
transmit, to a server, first position information associated with the first user of the electronic device and first point-of-interest (POI) information associated with the first user,
receive, from the server, one or more recommended POIs determined by the server based at least in part on the first position information, the first POI information, second position information associated with the second user, and the second POI information,
display in the user interface of the shared mapping session at least one of a travel time or a travel route from a departure location of the first user to the location of the one or more recommended POIs, and
display in the user interface of the shared mapping session a location of the one or more recommended POIs that is simultaneously viewable in the shared mapping session to the second user via the second electronic device.

11. The electronic device of claim 7, wherein the one or more processors are configured to:
in response to a determination that the electronic device is co-located with the second electronic device, automatically transmit invitation information to the second electronic device to join the shared mapping session, and
in response to a determination that the electronic device and the second electronic device are no longer co-located, automatically terminate the shared mapping session.

12. The electronic device of claim 7, wherein the one or more processors are configured to:
in response to a determination that the electronic device and the second electronic device are co-located with one another and an accuracy of a location measured by the electronic device is less than a threshold value, obtain location information from at least one sensor of the second electronic device to improve the accuracy of the location measured by the electronic device.

13. A computer-implemented method for a shared mapping session, the method comprising:
receiving a request to initiate the shared mapping session which includes a plurality of electronic devices including a first electronic device having a first user and a second electronic device having a second user;
receiving, from the first electronic device via the shared mapping session, first point-of-interest (POI) information associated with the first user, the first POI information including a visual element to identify a first POI as an item of interest to the first user; and
transmitting the visual element to the second electronic device so that the visual element is simultaneously viewable in the shared mapping session to the second user via the second electronic device and the first user via the first electronic device.

14. The computer-implemented method of claim 13, further comprising:
receiving a request from the first electronic device to provide a real-time map view of the shared mapping session from a point of view of the second user of the second electronic device; and
in response to receiving the request, transmitting the real-time map view of the shared mapping session from the point of view of the second user of the second electronic device to the first electronic device.

15. The computer-implemented method of claim 13, further comprising:
transmitting second navigation information to the first electronic device, the second navigation information indicating at least one of a travel time or a travel route from a departure location of the second user to a location of the first POI, such that at least one of a travel time or a travel route from the departure location of the second user to the location of the first POI is viewable to the first user in the shared mapping session simultaneously with at least one of a travel time or a travel route from a departure location of the first user to the location of the first POI.

16. The computer-implemented method of claim 13, wherein
receiving first position information associated with the first user and second position information associated with the second user;
receiving second POI information associated with the second user;
determining based at least in part on the first position information, the second position information, the first POI information, and the second POI information, one or more recommended POIs; and
transmitting the one or more recommended POIs to the first electronic device and the second electronic device such that the one or more recommended POIs are simultaneously viewable in the shared mapping session to the first user via the first electronic device and the second user via the second electronic device.

17. The computer-implemented method of claim 16, further comprising:
in response to receiving a query from the first electronic device for one or more recommended POIs, obtaining a plurality of candidate recommended POIs based on one or more search results corresponding to the query; and
ranking each of the plurality of candidate recommended POIs based in part on search criteria from the query and user profile information of at least one user other than the first user among users of the plurality of electronic devices in the shared mapping session, and
wherein
determining the one or more recommended POIs is further based in part on the ranking of each of the plurality of candidate recommended POIs.

18. The computer-implemented method of claim 17, wherein
ranking each of the plurality of candidate recommended POIs is further based in part on at least one of a travel time or a travel route from respective departure locations associated with each user of the plurality of electronic devices in the shared mapping session to respective locations of each of the plurality of candidate recommended POIs.

19. The computer-implemented method of claim 13, further comprising:
in response to the first electronic device being determined to be co-located with the second electronic device, automatically transmitting invitation information to the second electronic device to join the shared mapping session; and
in response to determining the first electronic device and the second electronic device are no longer co-located, automatically terminating the shared mapping session.

20. The computer-implemented method of claim 13, further comprising:
in response to determining the first electronic device and the second electronic device are co-located with one another and receiving information indicating an accuracy of a location measured by the first electronic device is less than a threshold value, obtaining location information from at least one sensor of the second electronic device; and
providing the location information obtained from the at least one sensor of the second electronic device to the first electronic device to improve the accuracy of the location measured by the first electronic device.
